(19) United States
(12) Patent Application Publication
(10) Pub. No.: US 2010/0076790 A1
(43) Pub. Date: Mar. 25, 2010

(54) Health-care exchange IV

(76) Inventor: Anuthep Benja-Athon, New York, NY (US)

Correspondence Address: ANUTHEP BENJA-ATHON, 210 E 36th St., NEW YORK, NY, 10016, US

(21) Appl. No.: 12/592,714

(22) Filed: Dec. 2, 2009

Related U.S. Application Data
(63) Continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 12/156,674, filed on Jun. 4, 2008.
Application No. 12/156,674 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/327,973, filed on Jan. 9, 2006, now abandoned.
Application No. 11/327,973 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 12/322,529, filed on Feb. 4, 2009.
Application No. 12/322,529 is a continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 11/242,461, filed on Oct. 4, 2005, now abandoned.

(51) Int. Cl. G06Q 50/00; G06Q 10/00

(52) U.S. Cl. 705/3; 705/2

(57) ABSTRACT

A system and method for effecting patterns, standards, consensuses and logics of the practice of medicine by physicians using adaptable compositions of information and data on diagnoses, health, health-care and health-care services and of health-care accounts to increase physicians' productivity and preserve physicians', patients' and health-care buyers' resources.

This application is a continuation-in-part of ABA0909 filed Sep. 1, 2009 entitled the Health-care exchange III, a continuation-in-part of Ser. No. 12/381,654 entitled the Adaptable compositions of health information filed Mar. 16, 2009, a continuation-in-part of Ser. No. 12/321,141 entitled the Best system of health and health-care data management filed Jan. 16, 2009 which is a continuation-in-part of Ser. No. 12/069,409 entitled the Filing of Health and Health-care data filed Feb. 11, 2008, a continuation-in-part of Ser. No. 12/156,674 filed Jun. 4, 2008 entitled a precise medical information retrieval, a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007 (abandoned), a continuation-in-part of Ser. No. 11/637,662 entitled A vital hierarchy of data on diseases filed Dec. 13, 2006 (abandoned), a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006 (abandoned), a continuation-in-part of Ser. No. 11/477,121 entitled the Medical Vocabulary Templates in Speech Recognition filed Jun. 29, 2006 (abandoned), a continuation-in-part of Ser. No. 11/327,973 filed Jan. 9, 2006 entitled Fidelity of physicians' thoughts to digital data conversions (abandoned), a continuation-in-part of Ser. No. 11/114,763 entitled A system of influencing health-care utilizations filed Apr. 27, 2005 (abandoned), a continuation-in-part of Ser. No. 11/196,823 entitled Routing of health information files filed Aug. 4, 2005 (abandoned), a continuation-in-part of Ser. No. 11/973,866 entitled An intelligent system of speech recognizing physicians' data (abandoned), a continuation-in-part of Ser. No. 11/293,689 entitled A system of conserving health-care buyers' resources filed Dec. 5, 2005 (abandoned), a continuation-in-part of Ser. No. 11/150,878 entitled Physicians' optimal management of health information filed Jun. 13, 2005 (abandoned), a continuation-in-part of Ser. No. 11/074,236 entitled A system of management of health-care resources filed Mar. 7, 2005 (abandoned), and a continuation-in-part of Ser. No. 11/022,410 entitled Physicians' way of information productions filed Dec. 27, 2004 (abandoned), a continuation-in-part of Ser. No. 12/322,529 filed Feb. 4, 2009 entitled the Healthcare exchange II, a continuation-in-part of Ser. No. 12/080,433 filed Apr. 3, 2008 entitled Healthcare exchange, a continuation-in-part of Ser. No. 12/072,097 filed Feb. 25, 2008 entitled a Method of empowering owners of health-care resources, and a continuation-in-part of Ser. No. 11/242,461 filed Oct. 4, 2005 entitled a Perfect system of compensations for physicians which are pending.

### FIELD OF INVENTION

Physician-computer hybrid system for managing health and health-care resources.

### BACKGROUND OF THE INVENTION

The concepts of and means for generating and managing health and health-care data and information on patients by physicians and health-care resources of patients and physicians and the incorporations into and relations of said data and information to the larger health and health-care data and information generated by patients and physicians are taught in said pending patent applications.

However, a more advanced and adaptable system and method of using the means for filing, relating, managing and expanding health, health-care and health-care-service information and data on patients and physicians and health-care resources for effecting the associations, incorporations, relations and managements of said information and data by said patients, physicians and computer servers were heretofore either not achieved, described or not detailed. Said pending patent applications and the present invention provide a system and a method to achieve the objectives and goals described herein.

The present invention—an even more advancement and innovative of said pending patent applications capable of further improving the health-care system—provides an even more versatile and adaptable system of compositions on information and data on diagnoses, diseases, disorders and related health, health-care and health-care services and physicians' and patients' health-care resources and a more versatile method for managing said information and data and their derivatives being generated and compiled said related information and data in the databases in a SQL server to enhance or optimize the accuracy of the recording of said information and data, to assist with and/or facilitate the medical decision makings and reduce or eliminate errors in decision makings of physicians, to improve and increase the efficiency of the processes for generating and recording health and health-care and health-care resource information and data, to expedite the process or processes of entering and recording of said information and data into said database or databases by physicians, patients and/or computer server or servers and to reduce the repetitive efforts of physicians' productions of same or similar said information and data and relating errors and to improve the efficiency of deliveries of and utilizations of health-care and health-care services and resources.

The present invention together with said pending patent applications are the only means and solution for solving the current health and health-care woes affecting all Americans and, consequently, they produce the best health-care system the world ever known and have and the benefits for billions of people and humanity are immense.

### SUMMARY OF THE INVENTION

The present invention provides a versatile and adaptable compositions and successive editions or updates of information and data on diagnoses of diseases and disorders and related health, health-care and health-care services and related adaptable compositions and successive editions or updates of compositions of accounts on payments and distributions of payments credited to physicians' accounts and compositions of accounts on disbursements of and refunds to patients' accounts generated by physicians and a computer, computer server or servers and for the managements of information and data on health, health-care and health-care services and the practice of medicine and surgery by physicians and a system of patterns, standards, consensuses and logics on the practices of medicine and surgery and dispensations and deliveries of health, health-care and health-care services by physicians.

### BRIEF DESCRIPTION OF THE PREFERRED EMBODIMENTS

To understand the preferred embodiments of the present invention, however, it is necessary to mention herein said earlier patent applications such as, but not limited to, ABA0909 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II and Ser. No. 12/080,433 entitled the Healthcare exchange, Ser. No. 12/322,529 filed Feb. 4, 2009 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians.

In at least one pending patent application providing a method for composing information and data on diagnoses of diseases and disorders and health, health-care and health-care services relating to said diagnoses for managing information and data on health, health-care and health-care services by physicians and for the administrating physicians', health-care consumers' and health-care buyers' health-care resources in a network or networks of computer servers, computers and portable communication devices wherein the contents of said compositions comprising diagnoses of diseases and disorders and said information and data are derived from information and data on or relating to diagnoses, diseases, disorders, health, health-care and health-care services generated by physicians wherein said information and data are submitted, processed, related, stored and compiled in the database or databases of the computer server, computer servers, computer or computers in said network or networks wherein said contents of said compositions are repetitively composed and/or compiled from said submitted, processed, related and compiled information and data in said database or databases wherein said compositions are repetitively retrieved from said database or databases and the information and data and contents of said compositions are repetitively manipulated, modified, edited and/or improved by physicians and are submitted into and processed, related, stored, compiled in said database or databases, wherein redundant repeats, doubles and/or duplicates or redundances of information and data occurring in every submission of said information and data and/or said composition by every physician and redundant repeats, doubles and duplicates or redundances of information and data occurring in submissions of information and data and/or compositions on or relating to same diagnosis, disease or disorder by physicians are scanned and processed to result in the submissions of said information and data and compositions on or relating to same diagnosis, disease or disorder having no redundant repeat, double and duplicate into and/or in said database or databases wherein said results are related, pooled and/or compiled, wherein retrieved said compositions comprise no redundant repeat, double and duplicate or information and data are repetitively viewed, manipulated, modified, edited and/or improved and used by physicians, wherein said information and data and compositions are repetitively retrieved from said database or databases and viewed, manipulated, modified, edited and/or improved and used by physicians on interactive electronic templates on viewing screens of said computers and portable communication devices, and relating monetary values representing prices or monetary values of said health-care and health-care services generated, related and stored in said database or databases by said computer programs and software wherein queries, choices and options and responses with regards to appointments and schedules and prescribing, ordering, fulfilling of prescriptions and records of dispensations of prescriptions and medications are sent or transmitted back and forth between physicians and pharmacists and staff people to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors.

In brief, said pending patent application provides the generations and applications of the versatile, adaptable and expandable compositions of information and data on diagnoses of diseases and disorders and health, health-care and health-care services on and relating to said diagnoses of diseases and disorders for physicians for concordant management of information and data on health, health-care and health-care services wherein said adaptable compositions are generated, used and enlarged by physicians of different and diverse medical and surgical specialties or practices and by an innovative computer program and software invented and created by the present patent applicant was taught.

In addition to supra, the present invention also provides physicians with individual diagnoses in individual groups of same or similar diagnoses of diseases and disorders and related information and data on health, health-care and health-care services generated by physicians and input into and processed, scanned, duplications eliminated, submitted, related and compiled in the database or databases in and manage by a SQL server and by a computer, a computer server or servers from which more innovations are produced as described infra.

Therefore, said pending patent and present applications provide individual physicians of about 85 medical and surgical specialties or practices with said innovative computer program and software for generating or producing individual compositions of information and data on or relating to individual DIAGNOSES on and relating to individual diseases and disorders and related health, health-care and health-care services produce and use by individual physicians to suit and be used by individual physicians and, in addition, individual diagnoses in individual groups of same, equivalent or similar diagnoses of diseases and disorders and related information and data on health, health-care and health-care services generated by physicians and input into said SQL server. Said information and data, in the processes of generating said compositions, are processed, scanned, duplications eliminated, submitted, related and compiled in the database or databases in and manage by said SQL server and by a computer, a computer server or servers. To be efficient, redundant words, terms and phrases generated by said physicians in each heading are scanned and selected so that said redundant words, terms and phrases or repeats, doubles or similars are removed from or not stored in said database or databases from which said compositions of said information and data are repetitively retrieved and manipulated, modified, edited and/or improved and further composed by physicians to suit and to be used by said individual physician composers to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors. Physicians of about 85 medical and surgical specialties or practices using computers and/or mobile communication devices from diverse and different locations access said computer server or servers via the Internet can retrieve said interactive electronic templates to enter and submit said information and data on or relating to diagnoses of diseases and disorders and related health, health-care and health-care services.

Said pending patent application provides successive editions, improvements, updating and expansions of said compositions by physicians and said computer, server or servers enabled by said SQL server.

Said pending patent application provides a process of retrieving and displaying and using said words and terms which are made interactive with individual patients and individual physicians to generate, display and use individual arrays or series of information and data on or relating to health, health-care, health-care services provided to individual patients by individual physicians such as, but not limited to, individual Diagnoses of diseases, disorders and illnesses of individual patients and diagnosis-related information and data such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imagings, Body Fluid Tests and Tissues Examinations, Assessments and Plans, Immunizations, Medications, Treatments, Surgeries, Recommendations, Guidelines, Reminders, Warnings, Referrals and Follow-ups generated and submitted by patients and physicians in the database or databases in and manage by said SQL server by individual patients and individual physicians. For example, using a word or a term representing a Diagnosis which is made interactive with a patient and his or her physicians on the viewing screens who have access to said information and data, by clicking said interactive word or term representing said Diagnosis, said patient and physicians can generate, display, view and use an array or a series of information and data on said Diagnosis and all relating health, health-care, health-care services such as, but not limited to, his or her said diagnosis on the disease, disorder or illness and all his or her Evaluation (s), Chief Complaint(s), Allergy(ies), Family History, Vital Sign Measurement(s), Review(s) of Systems, Physical Examination(s), Infectious Disease(s), Differential Diagnosis(ses), Result(s) of Laboratory(ies) such as, but not limited to, Imaging(s), Body Fluid Test(s) and Tissue(s) Examination(s), Assessment(s) and Plan(s), Immunizations, Medication(s), Treatment(s), Surgery(ies), Recommendation(s), Guideline(s), Referral(s) and Follow-up(s).

Further to supra, in addition to said generations, displays and uses of said individual arrays or series of information and data on or relating to health, health-care, health-care services, using said processes, related information and data on payable health-care services, treatments, procedures, tests and laboratories and said related accounting, utilizations, expenses, disbursements, payments, redistributions, adjustments, credits, account payables, receivables, collectibles and unpaid charges of services, revenues and earnings are also generated, displayed and used, appropriately, by individual patients and individual physicians.

Furthermore, said pending patent also provides a process of retrieving, displaying and using said words and terms which are made interactive with patients and physicians to generate, display and use individual arrays or series of related pooled or compiled information and data on health, health-care, health-care services provided to patients by physicians such as, but not limited to, individual Diagnoses of diseases, disorders and illnesses of patients and diagnosis-related information and data in such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imaging or Imagings, Body Fluid Tests and Tissues Examinations, Assessments and Plans, Immunizations, Medications, Treatments, Surgeries, Recommendations, Guidelines, Referrals and Follow-ups generated and submitted by patients and physicians in the database or databases in and manage by said SQL server by patients and physicians. For example, using a word or a term representing a Diagnosis which is made interactive with patients and physicians on the viewing screens who have access to said information and data, by clicking said interactive word or term representing said Diagnosis, patients and physicians can generate, display, view and use individual arrays or series of related pooled or compiled information and data on health, health-care, health-care services provided to patients by physicians on said Diagnosis and all diagnosis-relating health, health-care, health-care services such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imaging or Imagings, Body Fluid Tests and Tissues Examinations, Assessments and Plans, Immunizations, Medications, Treatments, Surgeries, Recommendations, Guidelines, Referrals and Follow-ups.

In addition, the present invention provides for the exchanges, changes, editions and/or updates of any versions of individual diagnoses or individual diagnoses in individual groups of same or similar diagnoses of diseases and disorders and any versions of related information and data on health, health-care and health-care services by physicians in any and all stages of the generations of said compositions, uses of said compositions, checking of information and data entries and in the charts. In other words, information and data on Diagnoses and relating information and data on Evaluation (s), Chief Complaint(s), Allergy(ies), Family History, Vital Sign Measurement(s), Review(s) of Systems, Physical Examination(s), Infectious Disease(s), Differential Diagnosis(ses), Result(s) of Laboratory(ies) such as, but not limited to, Imaging(s), Body Fluid Test(s) and Tissue(s) Examination(s), Assessment(s) and Plan(s), Immunizations, Medication(s), Treatment(s), Surgery(ies), Recommendation(s), Guideline(s), Referral(s) and Follow-up(s) generated, used and submitted into the database or databases in said SQL by physicians—in approximately 85 medical and surgical specialties and practices to document the services provided to patients by said physicians—can be versatilely and instantly edited in said stages and locations described herein by said physicians to exchange, edit, change, and/or update any versions of individual diagnoses or individual diagnoses in individual groups of same or similar diagnoses of diseases and disorders and any versions of related information and data on health, health-care and health-care services to edited or more updated versions of individual diagnoses or individual diagnoses in individual groups of same or similar diagnoses of diseases and disorders and any versions of related information and data on health, health-care and health-care services.

In other words, the present invention enables physicians to either hold or edit any versions of information and data on individual diagnoses and either hold or edit relating any versions of information and data health, health-care and health-care services in the database or databases in and manage by said SQL. In other words, the present invention enables physicians to edit first versions of individual diagnoses and relating first versions of health, health-care and health-care services to second versions of individual diagnoses and relating first versions of information and data on health, health-care and health-care services and successive versions of individual diagnoses and successive versions of health, health-care and health-care services relating said versions of individual diagnoses by physicians. First example, physicians can hold first versions of individual diagnoses and edit relating first versions of health, health-care and health-care services to produce second or successive versions of information and data on health, health-care and health-care services relating to first versions individual diagnoses. Second example, physicians can edit first versions of individual diagnoses and hold relating first versions of health, health-care and health-care services to produce second or successive versions of individual diagnoses relating to first versions of information and data on health, health-care and health-care services relating to second or successive versions of individual diagnoses. Third example, physicians can edit first versions of individual diagnoses and edit relating first versions of health, health-care and health-care services to produce second versions of information and data on individual diagnoses and second or successive versions of information and data on health, health-care and health-care services. Said information and data on said compositions, editions, changes, improvements, expansions and additions of information and data are in the database or databases in and manage by said SQL.

Therefore, the editions and submissions of said versions of individual diagnoses and versions of health, health-care and health-care services by physicians and submitted into the database or databases in and manage by said SQL corresponding effect the adaptable compositions of accounts on payments and proportional payments, distributions, redistributions, adjustments of payments credited to physicians' accounts and said related adaptable compositions of accounts on disbursements of health-care funds from patients' accounts corresponding to said payments credited to physicians' accounts and deductions from said physicians' accounts representing refunds to patients' accounts whose displays and uses by physicians and patients affect the patterning and managing of dispensations and logics of said dispensations of health care and health-care services to patients by physicians and patterning and managing the utilizations of and logics of said utilizations of health care and health-care services by or of patients.

Said pending application and present invention provide systems and methods for physicians, patients and health-care buyers to control their health-care resources by patterning, influencing and managing patterning and managing the dispensations and logics of said dispensations of health care and health-care services to patients by physicians and patterning and managing the utilizations of and logics of said utilizations of health care and health-care services of or by patients and for managing physicians' compensations for health care and health-care services provided to patients and for managing patients' and health-care buyers' health-care funds and disbursements in the database or databases in and manage by said SQL in a network or networks of computers, portable and/or wireless communication devices and operating and functioning computer servers comprising said SQL. Therefore, further to supra, one of the preferred embodiments supra of the present invention provides and effects a more intelligent physician-computer hybridizing of the inventions of the present applicant.

Furthermore, the present invention provides yet another unique innovation comprising numerous innovative and unique processes for realistically, meaningfully, practically, logically and significantly improve or optimizing the current health-care system. As the results, consequences and outcomes of generating and editing or updating and using said information and data, said adaptable compositions and adding, updating, modifying or editing any versions of said information and data on individual diagnoses and said any relating versions of information and data on related health, health-care and health-care services and said successive versions of information and data and said individual adaptable compositions of information and data and said relating individual adaptable compositions of information and data on accounts by physicians and said computer or computer server or servers, the present invention further provides numerous processes for generating and displaying information and data on patterns, standards, consensuses and logics on the practices of medicine and surgery and the dispensations and deliveries of health, health-care and health-care services to individual patients by individual physicians and by individual physicians in individual groups of physicians relating to individual diagnoses and related health, healthcare and healthcare services provided and relating to individual patients by said individual groups of physicians and related information and data on payments to physicians' accounts and corresponding disbursements from patients's accounts, physicians' performances and related achievements and results and related clinical, scientific and medico-economic outcomes, results and implications in the database or databases in said SQL serve which vitally and significantly effect the processes for patterning and managing the dispensations of health-care and health-care services to individual patients by individual physicians and by individual physicians in individual groups of physicians relating to individual diagnoses and the dispensations of related health-care and health-care services to individual patients by individual groups of physicians and, therefore, affecting the dispensations, utilizations and managements of health, health-care and health-care services and resources of and by physicians and patients.

A representation of one of the numerous preferred embodiments of the present invention, the present invention provides for the displays and uses of individual, relative and comparative practices and deliveries of the practices of medicine and surgery and the dispensations, uses and deliveries of health, health-care and health-care services such as, but not limited to, evaluations, tests, laboratories, procedures, treatments, surgeries, plans of disease and disorder managements and treatments, referrals, follow-ups, recommendations, guidelines, to individual patients by individual physicians and by individual physicians—of same town, city, state and/or country and/or different and diverse medical and surgical specialties in same and/or different geographical locations such as towns, cities, states and/or countries and same or different and diverse standards and costs of living—in individual groups of physicians relating to individual diagnoses and related health, healthcare and healthcare services provided and relating to individual patients by said individual groups of physicians and related information and data on payments to physicians' accounts and corresponding disbursements from patients's accounts, physicians' performances and related achievements and results and related clinical, scientific and medico-economic outcomes, results and implications. In other words, physicians' accountability of standards and qualities, performances, differences and diversities of practices and deliveries of medical and surgical services and the dispensations, deliveries and managements of health, health-care and health-care services and information and data on and relating to health, health-care and health-care services and to individual patients by individual physicians and groups of physicians and related costs, expenses, payments, disbursements of health-care and health-care services described herein in various factors, settings, circumstances and locations can be accounted, analyzed, monitored, managed, modulated and modified. For example, one of the preferred embodiments of the present invention generate adaptable displays of information and data on the individual, relative and comparative utilizations, dispensations and prescriptions of health-care and health-care services as a representation of said items such as, but not limited to, tests and laboratories such as, but not limited to, x-rays, CTScans, MRI's, EEG's, electro-diagnoses, cytologies, blood and body fluid tests, etc. by individual physicians and by individual physicians—of same town, city, state and/or country and/or different and diverse medical and surgical specialties in same and/or different geographical locations such as towns, cities, states and/or countries and same or different and diverse standards and costs of living—in individual groups of physicians relating to individual diagnoses and related health, healthcare and healthcare services provided and relating to individual patients by said individual groups of physicians. Relating to the displays of individual adaptable compositions of accounts supra and infra, the present invention, therefore, provides the means for affecting and effecting the dispensations, utilizations and prescriptions of said health-care and health-care services leading to proper or optimal managements and utilizations of health, health-care and health-care services and resources of and by physicians and patients. Said representative preferred embodiment applies to evaluations, procedures, treatments, surgeries, plans of disease and disorder managements and treatments, referrals, follow-ups, recommendations, guidelines, etc.

Another representation of one of the numerous preferred embodiments of the present invention as described in the claims infra of the present invention is supported by the current technologies including, but not limited to, various computer programs and software available and use by many programmers and their program and software derivatives, said compositions and/or versions of information and data can be retrieved, viewed, edited or updated and used on U.S. Pat. No. 6,132,218 in various dimensions and dimensional and numerous sequential presentations and versatility including, but not limited to, virtual images of said patent and compositions. For example, the results of laboratories and tests can be presented and illustrated to improve and communicate information and data to patients. For example, how serum sodium levels can affect blood pressure and the composite sodium levels of patients compiled in the database or databases relating to patients and said conditions and diseases. For example, how blood glucose or lipoproteins, triglycerides and cholesterol levels, etc., can affect and influence various organs and their health and function and diseases and disorders and the composite glucose levels of patients compiled in the database or databases relating to patients and said conditions and diseases. For example, how fever and related symptoms and signs are caused and associated or related to many diseases and disorders—infectious and noninfectious causes and affect and influence various bodily systems and organs and their health and function and said fever, diseases and disorders and identifications, descriptions, illustrations, communications of and logical and therapeutic approaches—researches, uses, prescriptions of drugs, epidemiology, trackings, sciences, logics, evidences, effectiveness, conclusions, outcomes and results, etc., of said therapies and treatments—to said fever, diseases and disorders relating to patients and said conditions and diseases can be communicated to patients and physicians by the present invention.

In other words, the present invention provides realistic, meaningful, practical, logical and significant method and means for managing and treating various diseases and disorders including the most common and prevalent chronic diseases and disorders afflicting millions of people such as, but not limited to, cardiovascular, endocrinologic, musculoskeletal and neurologic and infectious diseases and related diseases and disorders and researches. For example, further to supra, the present invention provides realistic, meaningful, practical, logical and significant managements, preventions and treatments and reductions of socioeconomic costs of diseases and disorders such as, but not limited to, hypertension and diabetes and their complications and sequelae such as, but not limited to cardiovascular diseases including coronary artery diseases and strokes, based on said processes provided by the present invention. For example, information and data generated by tests, laboratories and frequent or daily measurements, for example, by patients in their homes or other facilities and settings, and registered or recorded in various electronic devices from which said information and data are instantly and continually transmitted and submitted via wireless, mobile and/or cable-connected connections or transmissions including via the Internet into the database or databases in the computer server or servers identified herein and be processed, related and compiled in and manage by said SQL server from which individual, relative and comparative information and data on said submissions, compositions and compilations in and managed by said SQL server are retrieved and displayed to patients and physicians by processes described herein. Furthermore, attached or incorporated with said information and data are viewable information and data on recommendations, guidelines, reminders, warnings, referrals and follow-ups relating to said diagnoses, diseases, disorders and related complications and sequalae by patients and physicians. The products of said processes are the patterning and managing said diseases and disorders and the dispensations, prescriptions, utilizations and improvements of health-care and health-care services and treatments including, but not limited to, prescriptions of medications and related treatments and recommendations and follow-ups and consumptions and uses of said medications and food including, but not limited to, salts such as sodium chloride, potassium chloride and other elements, carbohydrates including glucose and fats and related items, molecules and elements by physicians and/or patients.

Further to supra, the present invention provides practical and powerful research and development tools for researching, developing, applying, using and prescribing medications, drugs and vaccines and the like for diseases, disorders and human afflictions.

Said compositions and versions, displays, illustrations, statistics, guidelines, guidances, recommendations and related details, components, elements and derivatives can be displayed, viewed and used as words, terms, phrases, sentences, paragraphs, details, graphics, statistics, spreadsheets, illustrations and anatomical and organ details and illustrations, video, animations and representations such as, but not limited to, by the preferred embodiments in U.S. Pat. No. 6,132,218 entitled Images for communication of medical information in computer and the like by physicians using computers, laptops, mobile or wireless communication devices in a network or networks of computers, laptop, mobile or wireless communication devices and computer servers via the cable and wireless Internet.

In summary, further to supra, therefore, it is to be understood that the present invention enables and provides physicians, scientists, researchers, computer programmer or programmers and persons skill in the art and science of medicine, health-care and science and computer programming and uses and applications of computer technologies including computer programming and uses of computer programs and software with insights, knowledge, know-how, methods, processes and systems for using the information and data in the database or databases generated, related and compiled by said pending patent applications and the present invention to generate and effect the generations, extrapolations, compilations, manipulations, syntheses, displays and uses of said information and data and logics derived and/or generated from information and data and compositions described supra and infra and to further generate, improve and expand on said information and data and their derivatives for addressing matters and issues in or relating to and to solve problems affecting health, health-care and health-care services.

In said instances, the present invention further provides a process of retrieving, displaying and using said processes and interactive words and terms representing individual diagnoses and individual diagnoses in individual groups of same or similar diagnoses relating to said physicians and individual patients relating to said individual diagnoses provided with said health-care and health-care services and related health, health-care and health-care services which are made interactive with physicians and patients to generate, display and use logics on or relating to said information and data on health, health care and health care services and said dispensations and utilizations of health care and health-care services by physicians and patients, respectively, stored and compiled in the database or databases in said SQL server and in the memory or memories of said computer server or servers to patients and physicians. Said logics also encompass scientific and medical information and data, journals and literatures, discussions, arguments on or relating to said diagnoses and related treatments, surgeries and laboratories and testings, cost-effectiveness, cost effects, revenue effects, medical and legal issues, comments and warnings. Said information and data and journals and literatures, discussions, arguments and related are generated, stored and related in the memories of said computer server or servers. Said repetitive uses by physicians and patients further expand and improve the database or databases on said information and data in said SQL.

Further to supra, in addition to said generations, displays and uses said compositions or individual arrays or series of related pooled or compiled information and data on health, health-care, health-care services provided to patients by physicians, using said processes, related information and data on payable health-care services, treatments, procedures, tests and laboratories and said related accounting, utilizations, expenses, disbursements, payments, redistributions, adjustments, credits, account payables, receivables, collectibles and unpaid charges of services, revenues and earnings are also generated, displayed and used, appropriately, by individual patients and individual physicians.

The outcomes of said repetitive uses of said compositions and repetitive editions of said information and data and versions of information and data in the database or databases in and manage by said SQL by physicians are complex affects and effects on the adaptable or editable and changing compositions of accounts on payments and distributions of payments credited to physicians' accounts and compositions of accounts on disbursements of health-care funds from patients' accounts corresponding to said payments credited to physicians' accounts and deductions from said physicians' accounts representing refunds to patients' accounts generated by physicians, patients and said computer, computer server or servers and successive editions of said compositions by physicians and/or patients and said computer, server or servers enabled by said SQL server wherein information and data on prices, monetary values or costs of said health care and health-care services generated, submitted, stored, related and compiled in the database or databases in said SQL and enabled by a computer scripting language, a Web browser and innovative computer programs and software.

To understand said complex affects and effects, it is necessary to describe the invention in at least another said pending patent application which connect supra to the compositions of accounts supra and infra. In one of the claims of one of said pending patent applications: In a system for controlling health-care resources by physicians, patients and health-care buyers in an operating and functioning computer server or in the operating and functioning computer servers comprising a processor or a plurality of processors, memories, SQL server, computer scripting language programs, innovative computer programs and software which communicate with and command said SQL server and generate, store, manage, relate and retrieve information and data in the database or databases of said SQL server and manage information and data and resultant information and data outcomes and products generate and use by physicians, scan said information and data and resultant information and data outcomes and products, match information and data and retrieve said information and data and resultant information and data outcomes and products in the database or databases in and manage by said SQL server to be displayed and used by physicians, patients and health-care buyers, and a networking capability comprising the Internet Explorer, Web browser and Web server wherein first words and terms and information and data on health, health-care and health-care services used and use by physicians of all and diverse medical and surgical practices or specialties for and in the communications of said words and terms and information and data among and between physicians and between physicians and patients generated and submitted to and store in the database or databases in and manage by said SQL server and second words and terms generated, submitted to and store in the database or databases in and manage by said SQL and scanned and matched words and terms submitted and store in the database or databases in and manage by said SQL server and resultant information and data outcomes and products comprising words and terms and relating information and data on related payments or compensations for health-care and health-care services provided to patients by physicians represent by said words and terms and relating information and data on payments or compensations, computations and accounting for health-care and health-care services provided to patients by physicians and relating information and data on the deposits of funds and debits, deductions and/or disbursements from patients' and/or health-care buyers' deposits and/or funds corresponding to said payments or compensations to said physicians by and/or on the behalf of said patients and by and/or on the behalf of said health-care buyers and computations and accounting in said database or databases in and manage by said SQL server in said computer server or servers accessible, retrieve, view and use by physicians and patients using computers and/or portable electronic communication devices in a network or networks of computers, portable electronic communication devices and said computer server or servers to access, retrieve, view and use said information and data in the database or databases in and manage by said SQL server in said computer server or servers via Internet, a method of scanning and matching words and terms which are integral components of health, health-care and health-care-service information and data on or relating to individual patients generated and submitted by said physicians of all and diverse medical and surgical practices or specialties for and in the communications of said information and data among and between physicians and between physicians and patients in the database or databases in said SQL server in said computer server or servers with words and terms same, similar and/or equivalence of said words and terms and relating monetary values, prices or costs generated, related, entered into and store in the database or databases in said SQL server in said computer server or servers and a process of scanning and matching words and terms used by physicians by retrieving, viewing and using said words and terms in the database or databases in said SQL server with words and terms same, similar and/or equivalence of said words and terms and relating monetary values, prices or costs store and manage in said SQL server in said computer server or servers to generate or create and manage the resultant information and data outcomes and products of said processes on or relating to payments or compensations for health-care and health-care services provided to patients by physicians, on the information and data on or relating to the deposits of funds and debits, deductions and/or disbursements from patients' and/or health-care buyers' deposits and/or funds corresponding to said payments or compensations to said physicians by and/or on the behalf of said patients and by and/or on the behalf of said health-care buyers submitted and store in the database or databases in and manage by said SQL server in said computer server or servers and to use said words and terms to inform physicians of erroneous words and terms generated and submitted by said physicians, to change, correct or edit erroneous words and terms by said physicians, to enable patients to dispute payments, to hold payments in abeyance, to enable physicians to respond to patients' disputes and to implement payments to physicians in said computer server or servers and to enable physicians, patients and health-care buyers to use computers and/or portable electronic communication devices in a network or networks of computers, portable electronic communication devices and said computer server or servers to transmit said information and data to and to access said database or databases in said SQL server in said computer server or servers and to enable physicians and patients to retrieve, view and use said information and data, payments, computations and accounting of said payments or compensations, deposits, debits, deductions and disbursements in said database or databases via the Internet by physicians, patients and health-care buyers to effect the control of health-care resources by physicians, patients and health-care buyers, to benefit said physicians, patients and to improve the standard of living and quality of health-care and life of said people and the benefit said health-care buyers comprises.

In other words, information and data on Evaluations, Laboratories, Treatments, Surgeries relating to individual diagnoses generated, used and submitted into the database or databases in said SQL by physicians using said compositions and editions—related to monetary values, prices or costs store and manage in said SQL server—enabled by the innovative computer programs and software identified herein, to computer-automatically generate and edit or expand the adaptable compositions of accounts on payments to individual physicians' accounts and/or distributions, redistributions, adjustments of payments also known as proportional payments between or among physicians' accounts relating to individual diagnoses and related health-care and health-care services and relating individual patients care for by said individual physicians involving certain factors and in certain settings and circumstances such as, but not limited to, diagnoses, chronicity of diseases, illnesses, disorders, chronology, time, durations, onsets and/or terminations, provocations and palliatives of and regions of bodies affected or afflicted by, severity of said diseases, illnesses, disorders, types and lists of treatments, procedures, surgeries, medications and drugs used for and treat supra; availabilities, amounts and sources of health-care funds and resources, evaluations, referrals, recommendations and follow-ups and the adaptable compositions of accounts on disbursements of or refunds to patients' health-care accounts corresponding to said payments credited to or debits from, respectively, said physicians' accounts.

In other words, the present invention provides a process for composing the accounts of the proportional payments, distributions and redistributions, adjustments or readjustments of payments between or among accounts of physicians relating to said health-care and health-care services relating to individual diagnoses or individual diagnoses in individual groups of same or similar diagnoses relating to said physicians and individual patients relating to said individual diagnoses provided with said health-care and health-care services and corresponding disbursements and refunds corresponding to said proportional payments, distributions and redistributions, adjustments or readjustments in the database or databases.

Further to supra and achievable with said processes, said information and data and information and data outcomes and products consequent to said uses and processing of words and terms which are integral components of said health, health-care and health-care-service information and data on or relating to diagnoses, diseases and disorders and related information and data infra and patients used and use by physicians of all and diverse medical and surgical practices or specialties for and in the communications of said information and data among and between physicians and between physicians and patients generated and used and submitted to the database or databases in and manage by said SQL server, of words and terms same as, similar to and/or equivalence of said words and terms and relating prices, monetary values or costs of said services generated, submitted, stored, related and compiled in the database or databases in and manage by said SQL server and the scanning, checking and matching of said words and terms, in particular said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, as described supra, with said words and terms same as, similar to and/or equivalence of said words and terms and relating prices, monetary values or costs of said services in the database or databases in and manage by said SQL server, one of the preferred embodiments of the present invention provides and effects the automatic generations, managements and maintenances of adjustable—higher or lower or variable—payments, adjustments to individual payments, distributions or redistributions of payments pertaining or relating to individual diagnoses and relating procedures and treatments delivered by individual physicians or individual groups of physicians of same or diverse medical and surgical specialities who are involved in the health care of and/or provide health-care services to individual patients. Using said words and terms in said categories or headings of Diagnosis, Evaluation, Laboratories, Imaging, Body Fluid Tests and Tissues Examination, Medications, said outcomes and products are used by the present invention to provide the accounting and displaying of payments, distributions, redistributions, adjustments, disputes, appeals, credits, debits, refunds, balances, revenues and earnings of physicians and/or individual physicians or individual groups of physicians providing health care and health-care services to individual patients on or relating to individual diagnoses generated, stored, related in the database or databases in and managed in said SQL server. In other words, said innovative computer programs and software of the present invention further provide the continual proportional distributions and adjustments or redistributions of payments to individual physicians or individual groups of physicians of same or diverse medical and surgical specialties pertaining or relating to individual diagnoses and relating services, procedures and treatments delivered by individual physicians or individual groups of physicians of same or diverse medical and surgical specialities who are involved in the health care of and/or provide health-care services to individual patients. In other words, the present invention provides processes for managing, manipulating and using the components of said information and data and information and data outcomes and products in the database or databases in and manage by said SQL server to generate arrangements or combinations of diverse payment arrangements or payment schedules of said services, procedures and treatments provided to patients by physicians to individual physicians or individual groups of physicians ranging from a first payment schedule wherein individual diagnoses relate to individual payments are only paid to individual physicians providing said services to individual patients to a second payment schedule wherein proportional distributions or adjustments or redistributions of payments among physicians of same and/or diverse medical and/or surgical specialties pertaining or relating to individual diagnoses and relating services, procedures and treatments delivered by said individual groups of physicians who are involved in and/or have provided health care and health-care services to individual patients. Furthermore, individual words and terms representing evaluations, procedures, treatments, surgeries, medications, laboratories and tests, etc. in said headers are related to prices, monetary values or costs representing prices, monetary values or costs of said health care and health-care services provided to patients by physicians in same or different and diverse localities.

In other words, a simplistic explanation of an expansive system—for a given diagnosis established for a patient by a physician providing health-care service or services to said patient from the beginning to the end of said health care for said diagnosis, said physician's account is credited in full payment. However, on the other hand, if said physician in said setting involve other physician or physicians of same or different medical and surgical specialties providing health care and health-care services to said patient and/or said other physician or physicians involve more physician or physicians to provide health care and health-care services to said patient, then all physicians providing health care and health-care services pertinent to said given diagnosis share proportions or percentages of an assigned fee, fees or combined fees of said health care and health-care service or services.

For first example, to simplistically explain said numerous, complex and diverse payment arrangements or schedules, a Comprehensive Consultation is assigned a monetary value of $200 and an Injection is assigned monetary value of $150 in Washington, D.C. and an antibiotics is assigned a price of $30. In a setting in Washington, D.C., a patient sees a physician A who administered said two procedures and said antibiotics based on a diagnosis of Cellulitis. If said patient's diagnosis is correct and patient is cured wherein the establishment of said diagnosis resulted in said procedures and use of said appropriate antibiotics, said physician A's account in said database or databases in and manage by said SQL is credited with said sum of $380.

On the other hand, however, to explain said numerous, complex and diverse payment arrangements or schedules using simple example, said physician A is not successful in curing said patient and, based on a diagnosis of Cellulitis, needs to refer said patient to another physician B of same specialty or different specialty such as an infectious disease physician B who provides a Simple Consultation assigned a monetary value of $50 and an oral antibiotics of $10 and physician B is able to cure said patient. In said entire setting, the proportional payments to physician A minus the payments to physician B as a result of applying a deduction to earlier physician A's payments are Comprehensive Consultation $200−Simple Consultation $50=$150 representing reduced payment credited to physician A's account, said injected antibiotics $30−said oral antibiotics $10=$20 representing reduced payment credit to physician A's account. The outcome of yet another simple example representing numerous, complex and diverse payment arrangements or schedules, is that physician A's account is readjusted or debited and credited with only $150+$150+$20=$320 and some of said money is redistributed to physician B's account which is credited with only $50+$10=$60.

For second example, to further simplistically explain said numerous, complex and diverse payment arrangements or schedules using yet another simple example, a Brief Consultation is assigned a monetary value of $100 and an Injection is assigned monetary value of $75 in Florida and an antibiotics is assigned a price of $15 and a throat culture is assigned a price of $10. In a setting in Florida, a second patient B sees a physician X who administered said three procedures and said antibiotics based on a diagnosis of throat infection. If said patient's diagnosis is correct and patient is cured wherein the establishment of said diagnosis resulted in said procedures and use of said appropriate antibiotics, said physician X's account in said database or databases in and manage by said SQL is credited with said sum of $200.

On the other hand, explaining said one example, said physician X is not successful in curing said patient and, based on a diagnosis of throat infection, patient B see another physician Y of same specialty or different specialty such as another general practitioner physician Y who provides another or second Brief Consultation assigned a monetary value of $50 and an oral antibiotics of $5 and physician Y is able to cure said patient. In said entire setting, the proportional payments, distributions or adjustments to physician X minus the payments to physician Y as a result of applying a deduction to earlier physician X's payments are Brief Consultation $100−Simple Consultation $50=$50 representing reduced payment credited to physician X's account, said injected antibiotics $15−said oral antibiotics $5=$10 representing reduced payment credit to physician X' account. The outcome of yet another simple example representing numerous, complex and diverse payment arrangements or schedules, is that physician X's account is readjusted or debited and credited with only $50+$10+$10=$70 and some of said money is redistributed to physician Y's account which is credited with $50+$10=$55. More physicians—known or unknown to said physicians—of said money pertaining to said patient and said diagnosis or yet another diagnosis as described infra.

Further to and relating to supra, correspondingly, proportional debits, deductions and/or disbursements from patients' and/or health-care buyers' deposits and/or funds correspond to said payments, distributions, redistributions, adjustments to said physicians and among said physicians relating to individual diagnoses relating to individual patients by and/or on the behalf of said patients and by and/or on the behalf of said health-care buyers are submitted, stored and related in the database or databases in and manage by said SQL server. In other words, more physicians—individual physicians in individual group of physicians relating to individual diagnosis and related health, healthcare and healthcare services provided to individual patient by said individual group of physicians relating said composition of account of individual patient and relating corresponding said disbursements of and refunds or reimbursements to patient's accounts in the database or databases in said SQL server—may be involved in this setting to result in redistributions, adjustments of said money pertaining to said patient and said diagnosis and related to said services as described infra.

One of the preferred embodiments of the present invention, further to supra, unique to the present invention is a process for repetitively composing, editing or updating said compositions of information and data on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating information and data on accounts of individual patients' disbursements of and refunds or reimbursements to said patients' account corresponding to said disbursements of and refunds or reimbursements to patients' accounts in the database or databases in said SQL server effected by physicians successively editing or updating any versions of information and data on individual diagnoses or individual diagnoses in individual groups of same, equivalent or similar diagnoses of diseases and disorders and any versions of related information and data on health, health-care and health-care services relating to said diagnoses provided to patients by physicians for individual patients' information and data on health and health-care in the database or databases in and manage by said SQL server in said computer server or computer servers by individual physicians or individual groups of physicians relating to said diagnoses by physicians. For example, a physician can edit or update a first versions of individual diagnoses and/or relating first versions of health, health-care and health-care services, or for that matter, edit or update any successive versions of individual diagnoses and/or any successive versions of health, health-care and health-care services relating to said versions of individual diagnoses of a patient. As a result, related information and data on said physician's account on payments and distributions or deductions of payments—subtracting previous payments for edited out costs or prices of previous health-care and health-care services from said payments—to physician's account relating to said individual diagnoses and related health-care and health-care services on said patient are edited or updated or composed. In other words, to represent said simplistic example by using numerical dollars to explain said simplistic example, said physician used a first diagnosis Herniated Lumbar Discs Stone and relating first Evaluation comprising Consultation with relating price or cost of $400 and first Surgery comprising Lumbar Discectomy with relating price or cost of $1,000. In said composition of account in the database or database in said SQL server, said physician's account was credited with Lumbar Discectomy $1000 and Consultation $400 for a total payment of $1,400 and, correspondingly, Lumbar Discectomy $1000 and Consultation $400 would be shown in patient's composition of account and $1000 and $400 would be disbursed from related patient's composition of account to said physician's account in said database or databases. However, if said physician was to—change his mind—edit or update only one said version of health-care service comprising to Lumbar Discectomy $1000 which is edited to Lumbar Manipulation with relating price or cost of $50.00. As a result, a first diagnosis Herniated Lumbar Discs and relating first Evaluation comprising Consultation with relating price or cost of $400 remain the same in said compositions of accounts of said physician and patient. However, since said first Surgery comprising Lumbar Discectomy with relating price or cost of $1,000 is edited to Lumbar Manipulation with relating price or cost of $50, in said composition of accounts in the database or database in said SQL server, said physician's account was credited with $50 (Lumbar Discectomy $1000 is unrelated and archived in the database) and Consultation $400 for a total payment of $450 and, correspondingly, Lumbar Manipulation with relating price or cost of $50 (Lumbar Discectomy $1000 is unrelated and archived in the database) and Consultation $400 would be shown in patient's composition of account and $50 and $400 would be disbursed from related patient's composition of account to said physician's account in said database or databases.

In summary, in said simplistic representation of the preferred embodiments of the present invention, an adaptable and expanding composition of information and data on an accounts of a physician relating to patient in and manage by said SQL server generated and enabled by the present invention comprise sums of payments or earnings of said physician for health-care and health-care services provided to said patients by said physician plus additional payments or earnings of said physician for additional health-care and health-care services provided to said patients less or minus deductions, if any due to any editions or updates of said versions of diagnoses and/or related versions of information and data on health-care and health-care services and related to information and data on and relating to health-care and health-care services generated and submitted into and compiled in the database or databases in and manage by said SQL generated and submitted from all stages of the generations of said compositions, uses of said compositions, checking, editing, updating, expanding and improving of information and data in the patients' charts as taught in said pending patent applications and in the present invention relating to said patients, to said payments or earnings representing refunds or reimbursements to any said patients for edited or updated information and data on said information and data health-care and health-care services by said physician. Correspondingly, said adaptable and expanding compositions of accounts of said patients relating to said information and data in said physician's composition comprise disbursements of and refunds or reimbursements to patients' accounts relating to said physician's accounting in the database or databases in said SQL server.

Further to supra, the present invention provides proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and the present invention applies said innovation to individual adaptable and expanding compositions of information and data on individual accounts of physicians relating to individual adaptable and expanding compositions of accounts of said physicians in said individual groups of physicians relating to individual diagnoses and related health, healthcare and healthcare services relating to individual patients and—as taught supra and herein—information and data on individual compositions of accounts of said patients and relating information and data on health-care and health-care services generated and submitted into and compiled in the database or databases in and manage by said SQL generated and submitted from all stages of the generations of said compositions, uses of said compositions, checking, editing, updating, expanding and improving of information and data in the patients' charts as taught in said pending patent applications and in the present invention.

It is to be understood, therefore, that said examples are applicable on a much larger scale and for repetitively composing, editing or updating said adaptable and enlarging compositions of information and data on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating information and data on accounts of individual patients' disbursements of and refunds or reimbursements to said patients' account corresponding to said disbursements of and refunds or reimbursements to patients' accounts in the database or databases in said SQL server effected by physicians successively editing or updating any versions of information and data on individual diagnoses or individual diagnoses in individual groups of same, equivalent or similar diagnoses of diseases and disorders and any versions of related information and data on health, health-care and health-care services relating to said diagnoses provided to patients by physicians for individual patients' information and data on health and health-care in the database or databases in and manage by said SQL server in said computer server or computer servers by individual physicians or individual groups of physicians relating to said diagnoses by physicians.

Further to supra, far more extensive and complex, the present invention provides the process for processing repetitively compositions, editions or updates of said compositions of information and data on payments and distributions or deductions of payments to individual physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians consequent to said physicians composing, editing or updating any versions of information and data on individual diagnoses or individual diagnoses in individual groups of same, equivalent or similar diagnoses of diseases and disorders and any versions of related information and data on health, health-care and health-care services relating to said diagnoses provided to patients by physicians for individual patients' information and data on health and health-care in the database or databases in and manage by said SQL server in said computer server or computer servers by individual physicians or individual groups of physicians relating to said diagnoses by physicians.

In addition to supra—said simplistic representations of one of the preferred embodiments of the present invention—in practice, the present invention also provides a process for processing multitude of combinations and generations of uses and applications of thousands of items or words and terms in various medical categories, headers or headings comprising said evaluations, tests, laboratories, procedures, treatments, surgeries, plans of disease and disorder managements and treatments, referrals, follow-ups, recommendations and guidelines to health-care and health-care services provided to individual patients by individual physicians and by individual physicians in individual groups of physicians relating to individual diagnoses and related health, healthcare and healthcare services provided to individual patients by said individual groups of physicians and relating information and data on prices, monetary values or costs of said health care and health-care services on and related to said health-care and health-care services are generated, related and compiled in the database or databases.

In other words, the present invention provides for combinations, schemes, schedules, scores or accounts for accounting or compositions of all payable health-care and health-care services in categories, headings or headers, such as, but not limited to, all items—words and terms—in the Evaluations, Tests, Laboratories, Procedures, Treatments and Surgeries relating to said diagnoses and relating to prices and costs of said words and terms relating to any and all physicians of any and all specialties in said compositions and versions of information and data and said compositions of physicians' compositions of payments and deductions and relating said compositions of patients' compositions of disbursements, refunds or reimbursements and balances and, of course, relating compositions of accounts of health-care buyers relating to said individual patients according to said preferred embodiments of pending patent applications and the present invention as described supra.

Therefore, the present invention applies its innovations and processes herein to generate, relate and compile information and data in the database or databases in and manage by said SQL server to generate, edit or update and expand successive compositions of information and data on individual accounts of physicians and individual physicians in individual groups of physicians relating to individual accounts of individual patients relating to individual diagnoses and individual diagnoses in individual groups of same, equivalent or similar diagnoses of diseases and disorders and related information and data on health-care and health-care services relating to individual patients and corresponding and relating individual adaptable and expanding successive compositions of information and data on individual accounts of patients relating to individual accounts of individual physicians and individual physicians in individual groups of physicians per supra and relating adaptable and expanding successive compositions of information and data on accounts of relating health-care buyers in the database or databases in and manage by said SQL server. Within said individual groups of physicians, said compositions of information and data of accounts of individual physicians are affected and effected by successive generations and editions or updates of compositions of accounts on payments and proportional payments, distributions and redistributions, adjustments and readjustments of payments between or among accounts of physicians credited to physicians' accounts relating to individual diagnoses and individual patients result in relating successive generations and editions or updates of compositions of accounts on disbursements of and refunds or reimbursements to patients' accounts corresponding to supra credited to and deductions from said physicians' accounts.

Similarly, said innovation and processes also account for disputes, appeals, credits, refunds or reimbursements and balances on and relating to accounts of said physicians, patients and health-care buyers in the database or databases in and manage by said SQL server.

Corresponding to said compositions of accounts of patients, said processes also affect and effect the relating adaptable compositions of accounts of health-care buyers viewable and useable by said buyers and/or their representative or staff.

Each said category, header or heading encompasses a vast amount of information and data including words and terms on or relating to health, health-care and health-care services which are used by physicians of all and diverse medical and surgical practices or specialties for and in the communications of said information and data among and between said physicians and between physicians and patients. Said information and data including said words and terms are found in numerous medical dictionaries and medical and surgical text books, journals, publications, literature and encyclopedias, etc. of said all medical and surgical specialties. For example, in the Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; in the heading of Laboratory comprises imaging, blood and tissue tests, analyses and examinations, electro-diagnoses, said words and terms number approximately many hundreds such as, but not limited to, x-rays, MRI's, CTScan's, PET Scans of various parts of the body, various types of blood tests, urinalyses, pathological analyses which are used by physicians in about 85 medical and surgical specialties or practices. However, in each of other said headings, said words and terms are very extensive. For example, under Diagnosis heading, there are all words and terms used and use by physicians in about 85 medical and surgical specialties on diagnoses of human diseases, illnesses and disorders; in Treatment heading, there are all words and terms used and use by physicians in about 85 medical and surgical specialties on the treatments of human diseases, illnesses and disorders such as, but not limited to, medical acupuncture, excision drainage, trigger point injection, bursa injection, vaccinations, etc.; in the Surgery heading, there are all words and terms used and use by physicians in about 85 medical and surgical specialties on the surgeries and surgical procedures of human diseases, illnesses and disorders such as, but not limited to, burr hole, craniotomy, cholecystectomy, splenectomy, arthroscopy, endoscopy, resections, etc.; in Medication heading, there are all medications and related information present in the Physicians' Desk Reference used and use by physicians in about 85 medical and surgical specialties. Anatomical structures and names are also used.

Said unique and innovative patent applications taught the use and implementation of the categories such as, but not limited to, Evaluation, Chief Complaint, Diagnosis, Treatment, Procedure, Surgery, Medication and Laboratory to enable and/or facilitate the organization, manipulation, processing and relating of health, health-care and health-care services generated and submitted by physicians in about 85 medical and surgical specialties. Further to supra, said pending applications and the present invention provide a process of scanning and checking of said words and terms, in particular scanning and matching said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, see also infra, with said words and terms same as, similar to and/or equivalence of said words and terms and relating prices, monetary values or costs of said services in the database or databases in and manage by said SQL to generate accounts of payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers generated, submitted, stored, related and compiled in the database or databases in and manage by said SQL server.

Said information and data including said words and terms are integral components of said health, health-care and health-care-service information and data on or relating to diseases and disorders and patients used and use by physicians of all and diverse medical and surgical practices or specialties for and in the communications of said information and data among and between physicians and between physicians and patients. Said information and data including said words and terms on or relating to health, health care and health-care services provided to patients by physicians are generated and submitted by physicians to be stored, related and compiled or pooled in the database or databases in and manage by said SQL server. Said information and data including said words and terms are continually and perpetually generated and submitted by physicians and are stored, related, compiled in the database or databases in and manage by said SQL server.

In addition, briefly herein although detailed in said pending patent applications, said information and data including words and terms on or relating to health care and health-care services are generated, submitted, stored, related, compiled or pooled in the database or databases in and manage by said SQL server and are retrieved—using computer mice, keyboards, physicians' or patients' fingers on the touch-enabled viewing screens and/or voice-activation and the like—by and displayed to physicians and patients as numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians and/or patients. Furthermore, in the preferred embodiments of said patent applications and the present invention, said word and term headers comprise Diagnosis, Evaluation, Chief Complaint, Review of Systems, Physical Examination, Infectious Diseases, Differential Diagnosis, Laboratories such as, but not limited to, Imaging, Body Fluid Tests and Tissues Examination, Assessment and Plan, Medications, Treatment, Surgery, Recommendations, Guidelines, Referral and Follow-up wherein said information and data including said words and terms are found and/or related.

Further to supra, based on above system and processes, various incentives offered to physicians for patterning and managing the dispensations of health-care and health-care services to individual patients by physicians can be implemented and effected.

The present invention further provides for said information and data in said preferred embodiments of the present invention to be related to information and data generated and submitted into and compiled in the database or databases in and manage by said SQL generated and submitted from all stages of the generations of said compositions, uses of said compositions, checking, editing, updating, expanding and improving of information and data in the patients' charts as taught in said pending patent applications and in the present invention.

It is to be understood that the present invention comprising method, processes, system, protocols, matters, products, functions and related and derivatives—implemented, effect and operate by said innovative computer software and program operating in said computer server or servers—are far more complex, extensive, intelligent, versatile and more than two dimensional and more versatilely, logically and relationally organized, arranged and presented than said brief and simple representations herein.

It is understood that further to supra, in addition to said words, terms, phrases and sentences stored and related in the database or databases in and manage by said SQL server, digits and alphanumerics can and are also used—albeit far less commonly than the uses and applications of said words, terms, phrases and sentences—in said information and data on health, health-care and health-care services provided to patients generated by physicians and said data on health-care services relate to same or equivalent data on health-care services and relating monetary values representing prices or monetary values of said services in the database or databases. In this setting, it is understood that the above can be and is adapted to incorporate this variation present in said data and information.

It is understood that the present invention is also able to convert said words, terms, phrases and sentences into corresponding digits and further modify or adapt the database or databases to comprise of digits within the spirit and scope of the claims of the present invention.

It is understood that patients are or can be health-care consumers and health-care buyers and employers, companies, corporations and governments are health-care buyers although employers are or can be patients. Health-care providers are physicians and other people who provided health and health-related services to people. Furthermore, the present invention also encompasses and enables families such as, children and minors, and dependents—by said definition—to achieve the goals and objects of the present invention operating in the U.S.A. and other nations. For example, in one of numerous preferred embodiments of the present invention, a head of a household such as, but not limited to, a father who works for a company—both may contribute funds or pay into the funds to pay for said health-care services—can have his spouse, children, dependent and/or dependents to access and use said funds to pay for said health-care services use by them. Furthermore, in yet one of numerous preferred embodiments of the present invention, said spouse, children, dependent and/or dependents can also contribute and/or add his, her and/or their own money and resources to said funds or, along with said funds, also use his, her and/or their owns and/or respective employer's or employers' money and resources, etc. Thus, in the preferred embodiments of the present invention, the objectives and goals of the present invention are achieved for all parties.

It is understood that the terms health-care, health care and healthcare have the same meaning and application and that the terms computer server and server have the same meaning and application. Also, it is understood that the term software is used herein as singular and pleural.

It is understood that health-care resources, credits, funds, payments, disbursements, reimbursements, totals, balances, etc. used herein are such as, but not limited to, dollars and cents and other foreign currencies and instruments of payment.

It is to be understood that said preferred embodiments and examples apply to physicians and information and data on diseases and disorders in about 85 medical and surgical specialties or practices.

Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

The present invention enhances or ensures the fidelity of said information and data being used and processed by said processes to produce accurate information and data outcomes and minimize errors for physicians, patients and health-care buyers by using said system and processes described supra and also effecting the retrievals and uses by physicians of said numerous interactive pop-ups and/or drop-down lists and/or menus and interactive graphics comprising said information and data and said words and terms in the database or databases in and manage by said SQL server to achieve the goals and objectives of the present invention. At least Java Script and AJAX and U.S. Pat. No. 6,132,218 entitled Images for communication of medical information in computer and the like—support by various technologies and their derivatives commercially available—are used to support interactive pop-ups and/or drop-down lists and/or menus and interactive graphics.

Therefore, physicians of about 85 medical and surgical specialties or practices using computers and/or mobile communication devices from diverse and different locations access said computer server or servers via the Internet can retrieve said interactive electronic templates to generate and/or use and submit said information and data including words and terms on or relating to diagnoses of diseases and disorders and related health, health-care and health-care services.

However, among said preferred embodiments of said pending patent applications and the present invention is a preferred embodiment wherein physicians still have the option of keyboarding to generate said information and data including said words and terms.

Further to supra, one of the preferred embodiments of said inventions and the present invention is the generation, relating and storage of said information and data including said words and terms and words and terms same as, similar and/or equivalent to said words and terms generated and submitted by said physicians as described supra—in the database or databases of said SQL server and have been generated and implemented by the present patent applicant and the quantity of said words and terms will continue to grow and enlarge as more words and terms are generated, entered and stored in the database or databases in and manage by said SQL server.

Further to supra, words and terms same as, similar and/or equivalent to said words and terms generated and/or used and submitted by physicians under the headers of health-care and health-care services comprises Diagnosis, Evaluation, Laboratories, Imaging, Body Fluid Tests and Tissues Examination, Medications, Treatment, Surgery are stored and related in the database or databases in said SQL and are related to monetary values representing prices or monetary values of said health-care and health-care services generated, related and stored in said database or databases in said SQL server. Similar to supra, said words and terms and relating monetary values or prices have been generated and implemented by the present patent applicant and the quantity of said words and terms will continue to grow and enlarge as more words, terms, prices or monetary values are generated, entered and stored in said database or databases. Said prices or monetary values are the billing rates—the costs or prices—for health-care and health-care services represent by the fees and payments for items represent by said words and terms for about 85 medical and surgical specialties such as neurology, orthopaedics, general surgery, etc. can be established as data in the database or databases in and manage by said SQL server and frequently added and/or edited.

Said unique and innovative pending patent applications and present invention further taught the scanning of submitted information and data including words and terms on health care and health-care services provided to patients by physicians generated and/or used by physicians, as described supra, with words and terms same as, similar to and/or equivalence of said words and terms in the database or databases and checking for redundant repeats, doubles or similars and/or errors. Redundant repeats, doubles or similars and/or errors in the submitted information and data are fixed so that there is no redundant repeat, double or similar submitted or present in the database or databases, and physicians are shown erroneous words and terms generated and submitted by said physicians so that said physicians are able to change, correct or edit erroneous words and terms.

Similarly, first, said unique and innovative patent applications and the present invention further taught the use of said words and terms are integral components of said health, health-care and health-care-service information and data on or relating to diseases and disorders and patients used and use by physicians of all and diverse medical and surgical practices or specialties for and in the communications of said information and data among and between physicians and between physicians and patients generated and used and submitted to the database or databases in and manage by said SQL server, the use of said words and terms same as, similar to and/or equivalence of said words and terms and relating prices, monetary values or costs of said services generated, submitted, stored, related and compiled in the database or databases in and manage by said SQL server and the scanning, checking and matching of said words and terms, in particular said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, as described supra, with said words and terms same as, similar to and/or equivalence of said words and terms and relating prices, monetary values or costs of said services in the database or databases in and manage by said SQL. Consequently, said words and terms enable and effect by said innovative computer programs and software and computer scripting languages and said SQL in said computer server or servers to generate information and data outcomes and products comprising payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers generated, submitted, stored, related and compiled in the database or databases in and manage by said SQL server. Furthermore, by using said words and terms, patients are enabled to dispute payments to physicians, to hold payments in abeyance, physicians are enabled to respond to patients' disputes and to implement payments to physicians. In other words, said preferred embodiments effect and provide the automatic generations, managements and maintenances of individual payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, Web browsers, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention.

Consequent to the incorporations of said data and information using computer programs, software mentioned herein and the like, the products of said incorporations are stored in and retrieved from database or databases to be displayed on the viewing screens and comprehensible and use by patients and physicians.

Having described some of the preferred embodiments of the present invention, said embodiments of the present invention can be extended to embody and provide a platform for a barter system or an exchange as a means for paying or compensating physicians by health-care consumers or health-care buyers wherein health and health-care resources produce by, derived from or of physicians can be exchanged or bartered with non-health and non-health-care goods and services produced, performed by, derived from or of patients and health-care buyers. These method and system for exchanging services and goods are applicable to said payments for said health-care and health-care services provided to individual patients to individual physicians and the proportional payments, distributions, adjustments, redistributions and readjustments of payments and debits among individual accounts of individual accounts of patients and individual physicians in individual groups of physicians relating to individual diagnoses and related health, healthcare and healthcare services provided to individual patients by said individual groups of physicians. This is useful for people and health-care buyers with either no or limited financial resources but have unused, excess or over-produced goods and services and/or other resources such as, but not limited to, skills, trades, items or matters of value.

Furthermore to supra, it is to be understood that the present invention provides or enables other scientists and persons skill in the art and science with insight, knowledge, methods and systems for generating, displaying and effecting the compilations, manipulations and syntheses of information and data derived and/or generated from the system, methods and processes taught by the present invention for addressing matters and issues in or relating and/or for solving problems affecting non-health-care systems, technologies, endeavors, enterprises and businesses.

Although various preferred embodiments of the present invention have been described, it is evident that the words and terms representing diagnoses in the specification and claims can, may and/or will include, encompass and/or apply to other medical and surgical words, terms and/or phrases such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imaging or Imagings, Body Fluid Tests and Tissues Examinations, Assessments and Plans, Immunizations, Medications, Treatments, Surgeries, Recommendations, Guidelines, Referrals and Follow-ups, etc. to achieve the goals and objectives of the present invention without departing from the spirit and the scope of the claims of the present invention.

Although various preferred embodiments of the present invention have been described, it will be appreciated by those skilled in the art that their adaptations, variations and derivatives may be made and achieved without departing from the spirit and the scope of the claims of the present invention.

1. A system of adaptable compositions of information and data on individual diagnoses and individual diagnoses in individual groups of same, equivalent or similar diagnoses of diseases and disorders and related information and data on health, health-care and health-care services and related adaptable compositions of accounts on and relating to said information and data on diagnoses and health, health-care and health-care services and on and relating to payments for said health-care and health-care services generated and expanded or updated by physicians and a computer, a computer server or servers wherein said information and data information and data on individual diagnoses and related health, health-care and health-care services are generated by physicians and input into and processed, scanned, duplications eliminated, submitted, related and compiled in the database or databases in and manage by a SQL server wherein information and data on prices, monetary values or costs of said health care and health-care services on and related to said health-care and health-care services are generated, related and compiled in the database or databases and wherein said related adaptable compositions of accounts on payments and distributions of payments credited to physicians' accounts and said related adaptable compositions of accounts on disbursements of health-care funds from patients' accounts corresponding to said payments credited to physicians' accounts and deductions from said physicians' accounts representing refunds to patients' accounts generated by physicians and said computer, computer server or servers and submitted, related and compiled in the database or databases in and manage by said SQL server and editions of versions of information and data on individual diagnoses or individual diagnoses in individual groups of same, equivalent or similar diagnoses of diseases and disorders and editions of related versions of information and data on related health-care and health-care services and editions of related versions of compositions of accounts and successive editions of related versions of information and data on individual diagnoses or individual diagnoses in individual groups of same, equivalent or similar diagnoses of diseases and disorders and successive editions of related versions of information and data on health, health-care and health-care services relating to said versions of diagnoses and successive editions of compositions of accounts by physicians and said computer, computer server or servers and manage by said SQL server for defining and affecting the dispensations of health-care and health-care services to patients by physicians and for effecting the payments for said health-care and health-care services to individual physicians and the proportional payments, distributions, adjustments, redistributions and readjustments of payments and debits among individual accounts of individual physicians in individual groups of physicians relating to individual diagnoses and related health, healthcare and healthcare services provided to individual patients by said individual groups of physicians and said compositions of accounts of individual patients and relating corresponding said disbursements of and refunds or reimbursements to patients' accounts in the database or databases in said SQL server and for composing said accounts on payments and distributions of said payments and/or said proportional payments, distributions and redistributions, adjustments and readjustments of payments between and among accounts of physicians corresponding to said payments in the database or databases in and manage by said SQL server in said computer server or servers in a network or networks of computers, mobile communication devices and said computer servers comprising memories, at least said SQL server, a computer scripting language, Web browsers and innovative computer programs and software wherein said information and data and compositions and the derivatives of said information and data and compositions are displayed, viewable and used by patients and physicians to improve the efficiency of deliveries of and utilizations of health-care and health-care services and resources, to reduce the costs and wastes of health-care and health-care services and in health-care, to efficiently and effectively manage information and data on health, health-care and health-care services provided to patients and for physicians and accounting of revenues and earnings of physicians and expenses and disbursements of health-care funds of patients and companies and corporations, to improve physicians' productivity, to improve the quality of health-care and life and to reduce morbidity and mortality of patients by physicians and patients comprises:
SQL database or databases comprising information and data on individual diagnoses of diseases and disorders and related information and data on health, health-care and health-care services;
SQL database or databases comprising information and data on individual diagnoses in individual groups of same, equivalent or similar diagnoses of diseases and disorders and related information and data on health, health-care and health-care services;
individual compositions of information and data on individual diagnoses and individual diagnoses in individual groups of same, equivalent or similar diagnoses of diseases and disorders and related health, health-care and health-care services generated by individual physicians and said computer or said computer server;
individual compositions of information and data on individual diagnoses and individual diagnoses in individual groups of same, equivalent or similar diagnoses of diseases and disorders and related health, health-care and health-care services generated by individual physicians and said computer or said computer server;
individual compositions of information and data on individual diagnoses and individual diagnoses in individual groups of same, equivalent or similar diagnoses of diseases and disorders and related health, health-care and health-care services generated by physicians and said computer or said computer server wherein said information and data are input into and processed, scanned, duplications eliminated, related and compiled in the database or databases in said SQL;
individual compositions of information and data on individual diagnoses and individual diagnoses in individual groups of same, equivalent or similar diagnoses of diseases and disorders and related health, health-care and health-care services generated by physicians and said computer or said computer server wherein said information and data are input into and processed, scanned, duplications eliminated, related and compiled in the database or databases in said SQL;
first versions of information and data on individual diagnoses or individual diagnoses in individual groups of same, equivalent or similar diagnoses of diseases and disorders and related first versions of information and data on related health-care and health-care services;
first versions of information and data on individual diagnoses or individual diagnoses in individual groups of same, equivalent or similar diagnoses of diseases and disorders and related successive versions of information and data on related health-care and health-care services;
successive versions of information and data on individual diagnoses or individual diagnoses in individual groups of same, equivalent or similar diagnoses of diseases and disorders and successive versions of information and data on related health, health-care and health-care services;
successive versions of information and data on individual diagnoses or individual diagnoses in individual groups of same, equivalent or similar diagnoses of diseases and disorders and first versions of information and data on related health, health-care and health-care services;
compositions of information and data on prices, monetary values or costs of said health care and health-care services on and relating to said health-care and health-care services;
dispensations of individual diagnoses or individual diagnoses in individual groups of same, equivalent or similar diagnoses of diseases and disorders and related information and data on health, health-care and health-care services by physicians;
individual and successive compositions of accounts on payments, distributions, redistributions or adjustments of said payments and credited to physicians' accounts;
individual and successive compositions of accounts on payments, distributions, redistributions or adjustments of said payments and proportional payments, distributions and redistributions, adjustments and readjustments of payments between or among accounts of physicians credited to physicians' accounts relating to individual diagnoses and individual patients;
individual and successive compositions of accounts on disbursements of health-care funds from patients' accounts corresponding to said payments credited to physicians' accounts and deductions from said physicians' accounts representing refunds of funds to patients' accounts;
individual and successive compositions of accounts on payments, distributions, redistributions or adjustments of said payments and credited to physicians' accounts relating to said dispensations of individual diagnoses or individual diagnoses in individual groups of same, equivalent or similar diagnoses of diseases and disorders and related information and data on health, health-care and health-care services by physicians;
individual and successive compositions of accounts on payments, distributions, redistributions or adjustments of said payments and proportional payments, distributions and redistributions, adjustments and readjustments of payments between or among accounts of physicians credited to physicians' accounts relating to individual diagnoses and individual patients relating to said dispensations of individual diagnoses or individual diagnoses in individual groups of same, equivalent or similar diagnoses of diseases and disorders and related information and data on health, health-care and health-care services by physicians;
individual and successive compositions of accounts on disbursements of and refunds or reimbursements to health-care funds from patients' accounts corresponding to said individual and successive compositions of accounts on payments, distributions, redistributions or adjustments of said payments and credited to physicians' accounts relating to said dispensations of individual diagnoses or individual diagnoses in individual groups of same, equivalent or similar diagnoses of diseases and disorders and related information and data on health, health-care and health-care services by physicians and/or to said individual and successive compositions of accounts on payments, distributions, redistributions or adjustments of said payments and proportional payments, distributions and redistributions, adjustments and readjustments of payments between or among accounts of physicians credited to physicians' accounts relating to individual diagnoses and individual patients relating to said dispensations of individual diagnoses or individual diagnoses in individual groups of same, equivalent or similar diagnoses of diseases and disorders and related information and data on health, health-care and health-care services by physicians;
SQL database or databases comprising said information and data;
SQL database or databases comprising said compositions on said information and data;
SQL database or databases comprising said information and data on said versions of individual diagnoses or individual diagnoses in individual groups of same, equivalent or similar diagnoses of diseases and disorders, versions of information and data on related health, health-care and health-care services;
SQL database or databases comprising information and data on said compositions of accounts on said payments, proportional payments, distributions and redistributions, adjustments and readjustments of payments, expenses, deductions or debits, disbursements, refunds and reimbursements and accounting.

2. In a system of adaptable compositions of information and data on individual diagnoses and individual diagnoses in individual groups of same, equivalent or similar diagnoses of diseases and disorders and related information and data on health, health-care and health-care services and related adaptable compositions of information and data on accounts on and relating to payments for health-care and health-care services generated and edited or updated by physicians and a computer, a computer server or servers wherein said information and data on individual diagnoses and individual diagnoses in individual groups of same, equivalent or similar diagnoses of diseases and disorders and related information and data on health, health-care and health-care services input into and processed, scanned, duplications eliminated, submitted, related and compiled in the database or databases in and manage by a SQL server and wherein relating information and data on prices, monetary values or costs of said health care and health-care services are generated, submitted, stored, related and compiled in the database or databases in and manage by said SQL server in said computer server or servers, a method for composing, editing or updating and using said compositions of information and data and for editing or updating and using first versions of individual diagnoses and relating first versions of health, health-care and health-care services and for editing or updating any successive versions of individual diagnoses and any successive versions of health, health-care and health-care services relating said versions of individual diagnoses by physicians for composing and editing or updating and using information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server generated by physicians and said computer, computer server or servers and for successively editing said compositions and versions of information and data by physicians and said computer or computer server or servers for defining and affecting the dispensations of health-care and health-care services to patients by physicians and the dispensations of individual diagnoses or individual diagnoses in individual groups of same, equivalent or similar diagnoses of diseases and disorders and related information and data on health, health-care and health-care services provided to patients by physicians for individual patients' information and data on health and health-care in the database or databases in and manage by said SQL server in said computer server or computer servers by individual physicians or individual groups of physicians relating to said diagnoses by physicians in a network or networks of computers, mobile communication devices and said computer servers comprising memories, at least said SQL server, said computer scripting language, at least said one Web browser and innovative computer programs and software for physicians and patients to view, use, edit and expand said information and data and compositions on the viewing screens of said computers and mobile communication devices to improve the efficiency of deliveries of and utilizations of health-care and health-care services and resources, to reduce the costs and wastes of health-care and health-care services and in health-care, to efficiently and effectively manage information and data on health, health-care and health-care services provided to patients and for physicians and accounting of revenues and earnings of physicians and expenses and disbursements of health-care funds of patients and companies and corporations, to improve physicians' productivity, to improve the quality of health-care and life and to reduce morbidity and mortality of patients by physicians and patients comprises:
a process for operating a network or networks of operating and functioning computer servers comprising a plurality of processors, memories, server operating system, a networking capability comprising a Web browser, Web server, SQL server, computer scripting language programs and innovative computer programs and software communicating with and commanding said SQL server;
a process for using said computer scripting languages and innovative computer programs and software to communicate with and command said SQL server;
a process for using said computer scripting languages and innovative computer programs and software to generate, expand and manage information and data in the database or databases in and manage by said SQL server;
a process for using computer scripting language programs and innovative computer programs and software tp communicate with and command SQL server and database or databases and Web browser;
a process for using said computer scripting languages and innovative computer programs and software for retrieving and displaying on Web pages said information and data in said database or databases in and manage by said SQL server;
a process for using said computer scripting language and innovative computer programs for generating, storing, relating and managing said information and data in said database or databases in and manage by said SQL server;
a process for using said computer scripting languages and innovative computer programs and software to generate, relate and manage health, health-care and health-care-service information and data and the health, health-care and health-care-services information and data products and outcomes of the generations, relations, managements and uses of said information and data in the database or databases which are submitted, stored, related, compiled or pooled in said database or databases in and manage by said SQL server;
a process for coupling a Web browser to said innovative computer programs and software and said SQL server and databases in said computer server or servers;
a process for generating, relating and managing health, health-care and health-care-service information and data and the health, health-care and health-care-service information and data products and outcomes of the generations, relations, managements and uses of said information and data in the database or databases which are submitted, stored, related, compiled or pooled in said database or databases in and manage by said SQL server;
a process for using said computer scripting languages and innovative computer programs and software to generate, relate and manage said information and data and said products and outcomes and to retrieve, display on Web pages, and to effect the views and uses of said information and data and products and outcomes by patients and physicians;
a process for defining and relating health-care and health-care services relating to individual diagnoses;
a process for relating information and data on health, health-care and health-care services relating to individual diagnoses of diseases and disorders and individual physicians;
a process for relating information and data on health, health-care and health-care services relating to individual diagnoses of diseases and disorders and individual physicians in individual groups of physicians relating to said individual diagnoses;
a process for defining and relating health-care and health-care services relating to individual diagnoses in individual groups of same, equivalent or similar diagnoses;
a process for relating information and data on health, health-care and health-care services relating to individual diagnoses of diseases and disorders and individual diagnoses in individual groups of same, equivalent or similar diagnoses of diseases and disorders and individual physicians;
a process for defining and relating health-care and health-care services relating to individual diagnoses and individual diagnoses in individual groups of same, equivalent or similar diagnoses to individual physicians;
a process for defining and relating health-care and health-care services relating to individual diagnoses and individual diagnoses in individual groups of same, equivalent or similar diagnoses to individual physicians in individual groups of physicians;
a process for generating and submitting information and data on health, health-care and health-care services and related diagnoses of diseases and disorders by physicians;
a process for generating and submitting information and data on health, health-care and health-care services and related individual groups of same, equivalent or similar diagnoses of diseases and disorders by physicians;
a process for compiling related information and data on health, health-care and health-care services relating to diagnoses of diseases and disorders from information and data on diagnoses, diseases, disorders and related information and data on health, health-care and health-care services generated by physicians;
a process for generating compositions of related information and data on health, health-care and health-care services relating to the diagnoses of diseases and disorders from said information and data on diagnoses, diseases, disorders, health, health-care and health-care services generated by physicians;
a process for editing or updating said compositions of related information and data on health, health-care and health-care services relating to the diagnoses of diseases and disorders and related said diagnoses and/or same, equivalent or similar diagnoses of diseases and disorders;
a process for composing and/or compiling related information and data on health, health-care and health-care services relating to diagnoses of diseases and disorders from said information and data on diagnoses, diseases, disorders, health, health-care and health-care services in said database or databases;
a process for composing information and data on diagnoses of diseases and disorders and health, health-care and health-care services on and relating to said diagnoses of diseases and disorders to suit and be used by physician composers of the compositions;
a process for scanning and processing redundant repeats, doubles and/or duplicates or redundances of information and data occurring in every composition, edition, update, improvement and/or submission by every physician;
a process for scanning and processing redundant repeats, doubles and duplicates or redundances of information and data occurring in compositions, editions, updates, improvements and/or submissions on or relating to same, equivalent or similar diagnosis, disease or disorder into said database or databases;
a process for submitting said information and data on or relating to same, equivalent or similar diagnosis, disease or disorder having no redundant repeat, double and duplicate into said database or databases;
a process for submitting said compositions on information and data on or relating to diagnoses, diseases and disorders having no redundant repeat, double and duplicate into said database or databases;
a process for generating and editing compositions of accounts on payments and distributions of said payments credited to physicians' accounts and compositions of accounts on disbursements of or refunds to patients' health-care accounts corresponding to said payments credited to or debits from, respectively, said physicians' accounts;
a process for generating and editing compositions of accounts on payments and distributions of said payments between or among physicians' accounts and compositions of accounts on disbursements of or refunds to patients' health-care accounts corresponding to said payments credited to or debits from, respectively, said physicians' accounts;
a process for retrieving and displaying and using individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process for using individual diagnoses to retrieve, display and use individual arrays or series of said information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process for using individual interactive diagnoses to retrieve, display and use individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process for retrieving, displaying and using individual arrays or series of related pooled or compiled information and data on or relating to health, health-care, health-care services in the database or databases in and manage by said SQL server by physicians and patients;
a process for retrieving, displaying and using individual arrays or series of related pooled or compiled information and data on or relating to health, health-care, health-care services and related funds, payments, proportional payments, distributions, redistributions, adjustments, disputes, appeals, credits, debits, refunds, balances, revenues and earnings in the database or databases in and manage by said SQL server by physicians and/or patients;
a process for using individual diagnoses to retrieve, display and use individual arrays or series of related pooled or compiled information and data on or relating to health, health-care, health-care services and related funds, payments, proportional payments, distributions, redistributions, adjustments, disputes, appeals, credits, debits, refunds, balances, revenues and earnings in the database or databases in and manage by said SQL server by physicians and/or patients;
a process for using individual interactive diagnoses to retrieve, display and use individual arrays or series of related pooled or compiled information and data on or relating to health, health-care, health-care services and related funds, payments, proportional payments, distributions, redistributions, adjustments, disputes, appeals, credits, debits, refunds, balances, revenues and earnings in the database or databases in and manage by said SQL server by physicians and/or patients;
a process for presenting logics on the dispensations and utilizations of health care and health-care services by physicians and patients stored, compiled and related in the database or databases in said SQL server and in the memory or memories of said computer server or servers to patients and physicians;
a process for using individual diagnoses to retrieve and display logics on the dispensations and utilizations of health care and health-care services by physicians and patients stored and compiled in the database or databases in said SQL server and in the memory or memories of said computer server or servers to patients and physicians;
a process for using individual interactive diagnoses to retrieve and display logics on the dispensations and utilizations of health care and health-care services by physicians and patients stored and compiled in the database or databases in said SQL server and in the memory or memories of said computer server or servers to patients and physicians;
a process for presenting supporting scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process for using individual diagnoses to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process for using individual interactive diagnoses to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process for patterning and managing the dispensations of health-care and health-care services to individual patients by individual physicians;
a process for patterning and managing the dispensations of health-care and health-care services to individual patients by individual physicians relating to individual diagnoses;
a process for patterning and managing the dispensations of health-care and health-care services to individual patients by individual physicians relating to individual diagnoses in individual groups of same, equivalent or similar diagnoses of diseases and disorders;
a process for patterning and managing the dispensations of health-care and health-care services to individual patients by individual groups of physicians relating to individual diagnoses;
a process for patterning and managing the dispensations of health-care and health-care services to individual patients by individual groups of physicians relating to individual diagnoses in individual groups of same, equivalent or similar diagnoses of diseases and disorders;
a process for patterning and managing the utilizations of health care and health-care services by individual patients;
a process for relating and compiling related and compiled information and data on relating diagnoses, diseases, disorders, health, health-care and health-care services in said database or databases;
a process for retrieving related and compiled information and data on relating diagnoses, diseases, disorders, health, health-care and health-care services in said database or databases for viewing and using by physicians;
a process for sending queries, choices and options and responses with regards to appointments and schedules and prescribing, ordering, fulfilling of prescriptions and records of dispensations of prescriptions and medications back and forth between physicians and pharmacists and staff people;
a process for retrieving, displaying and using words and terms which are integral components of health, health-care and health-care-service information and data on or relating to diseases and disorders and patients and are used by physicians of all and diverse medical and surgical practices or specialties for and in the communications of said information and data among and between physicians and between physicians and patients are generated, submitted, stored, related, compiled in the database or databases in and manage by said SQL server;
a process for retrieving, displaying and using said words and terms to generate, manage, relate, display, use, expand and improve information and data on health, health-care and health-care-services;
a process for retrieving, displaying and using said words and terms to generate, manage, relate, display, use, expand and improve information and data on health, health-care and health-care-services and on or relating health-care funds, payments, distributions, redistributions, adjustments, disputes, appeals, credits, debits, refunds, reimbursements, balances, revenues and earnings of physicians, patients and/or health-care buyers;
a process for retrieving and displaying and using said interactive medical words and terms representing diagnoses on or relating to individual patients to and interactive with physicians and patients to retrieve, display, use, expand, improve and manage said information and data on health, health-care and health-care-services in the database or databases in and manage by said SQL server;
a process for retrieving and displaying and using said interactive medical words and terms representing diagnoses on or relating to individual patients to and interactive with physicians and patients to retrieve, display, use, expand, improve and manage said information and data on health, health-care and health-care-services and on or relating health-care funds, payments, distributions, redistributions, adjustments, disputes, appeals, credits, debits, refunds, reimbursements, balances, revenues and earnings of physicians, patients and/or health-care buyers;
a process for retrieving, displaying and using information and data on health, health care and health-care services and relating prices, monetary values or costs generated, submitted, stored, related and compiled in the database or databases in and manage by said SQL server;
a process for retrieving, displaying and using information and data on health, health care and health-care services and relating funds, payments, distributions, redistributions, adjustments, disputes, appeals, credits, debits, refunds, reimbursements, balances, revenues and earnings of physicians, patients and/or health-care buyers generated, stored, related, compiled in the database or databases in and managed by said SQL server;
a process for generating, submitting, storing, relating, compiling and pooling words and terms which are components of health, health-care and health-care-service information and data on or relating to diseases and disorders and patients and are used by physicians of all and diverse medical and surgical practices or specialties for and in the communications of said information and data among and between physicians and between physicians and patients in the database or databases in and manage by said SQL server;
a process for generating, submitting, storing, relating, compiling and pooling information and data including said words and terms on or relating to health, health care and health-care services provided to patients by physicians which are generated and/or used and submitted by physicians and patients in the database or databases in and manage by said SQL server;
a process for generating, submitting and relating words and terms same as, similar to and/or equivalence of said words and terms in the database or databases in said SQL server;
a process for generating, submitting and storing words and terms same as, similar to and/or equivalence of said words and terms and relating monetary values representing prices, monetary values or costs of said health-care and health-care services in the database or databases in said SQL server;
a process for retrieving, displaying and using said words and terms by physicians and patients;
a process for retrieving, viewing and using said words and terms same as, similar to and/or equivalence of said words and terms in the database or databases by physicians and/or patients;
a process for retrieving, displaying and using said words and terms and relating monetary values representing prices, monetary values or costs of said health-care and health-care services in the database or databases in said SQL server;
a process for retrieving, viewing and using said words and terms same as, similar to and/or equivalence of said words and terms and relating monetary values representing prices or monetary values of said health-care and health-care services generated, related and stored in the database or databases in said SQL server;
a process for applying said innovative computer programs and software operating and functioning in said computer server or servers to scan said information and data and words and terms;
a process for applying said innovative computer programs and software operating and functioning in said computer server or servers to select matches of said words and terms;
a process for scanning words and terms which are integral components of first health, health-care and health-care-service information and data on or relating to individual patients generated and submitted by said physicians to the database or databases in said SQL server in said computer server or servers and words and terms same, similar and/or equivalent to said words and terms in the database or databases in said SQL server in said computer server or servers;
a process for matching words and terms which are integral components of health, health-care and health-care-service information and data on or relating to individual patients generated and submitted by said physicians to the database or databases in said SQL server in said computer server or servers with words and terms same, similar and/or equivalent to said words and terms in the database or databases in said SQL server in said computer server or servers;
a process for scanning words and terms generated and/or used and submitted by physicians;
a process for scanning words and terms used and submitted by physicians for redundant repeats, doubles or similars and/or errors;
a process for scanning words and terms used by physicians retrieving said words and terms from the database or databases in said SQL server and words and terms same, similar and/or equivalence of said words and terms and relating monetary values, prices or costs in the database or databases in said SQL server in said computer server or servers;
a process for matching words and terms generated and submitted by physicians and words and terms same, similar and/or equivalence of said words and terms in said SQL server;
a process for matching words and terms generated and submitted by physicians and words and terms same, similar and/or equivalence of said words and terms and relating monetary values, prices or costs which are stored and managed in said SQL server;
a process for matching words and terms used and submitted by physicians and words and terms same, similar and/or equivalence of said words and terms and relating monetary values, prices or costs which are stored and managed in said SQL server;
a process for selecting matches of said words and terms and relating prices, monetary values or costs of said health-care and health-care services in the database or databases in said SQL server in said computer server or servers;
a process for relating said information and data and said information and data outcomes and products of said matches of words and terms and selected relating prices, monetary values or costs in the database or databases in said SQL server in said computer server or servers;
a process for entering, storing and relating the products and outcomes of said scans of words and terms in the database or databases in and manage by said SQL server;
a process for entering, storing and relating the information and data outcomes and products of said matches of words and terms and selected relating prices, monetary values or costs in the database or databases in said SQL server;
a process for generating and storing said words and terms same, similar to and/or equivalence of said words and terms and relating monetary values, prices or costs generated, related, entered into and store in the database or databases in said SQL server;
a process for generating the information and data outcomes and products of matching said words and terms generated and submitted by physicians and said words and terms and relating monetary values, prices or costs which are stored and managed in said SQL server;
a process for generating the information and data outcomes and products of relating said words and terms used by physicians by retrieving said words and terms from the database or databases in said SQL server and said words and terms same, similar and/or equivalence of said words and terms and relating monetary values, prices or costs which are stored and managed in said SQL server;
a process for generating the resultant information and data outcomes and products of matching said words and terms generated and/or used by physicians with words and terms same, similar and/or equivalence of said words and terms and relating monetary values, prices or costs which are stored and managed in said SQL;
a process for storing and managing said resultant information and data outcomes and products of said matching said words and terms and relating monetary values, prices or costs in said SQL server;
a process for generating and maintaining accounts of physicians comprising information and data on payments, compensations, refunds and debits in the database or databases in said SQL server;
a process for using said words and terms to effect the generations, managements and maintenances of accounts of physicians comprising information and data on distributions, adjustments, redistributions, refunds, credits and debits in the database or databases in said SQL server;
a process for generating accounts of patients comprising deposits, debits, disbursements, refunds and credits in the database or databases in said SQL server;
a process for generating accounts of health-care buyers comprising deposits, debits, disbursements, refunds, reimbursements and credits in the database or databases in said SQL server;
a process for managing, accounting and displaying the deposits of and debits, deductions and/or disbursements from patients' and/or health-care buyers' deposits and/or funds corresponding to said payments or compensations to said physicians by and/or on the behalf of said patients and by and/or on the behalf of said health-care buyers in said SQL server;
a process for using said words and terms to inform and display for physicians said erroneous words and terms in said computer server or servers generate and submit by physicians;
a process for effecting changes, corrections and editions of said erroneous words and terms to correct words and terms in said computer server or servers by physicians to corrected words and terms;
a process for disputing payments and disbursements in said computer server or servers by patients;
a process for withholding payments to physicians in said computer server or servers by patients as the consequences of said patients' disputes;
a process for responding to patients' disputes and withholding of payments by physicians;
a process for implementing payments to physicians in said computer server or servers as the consequences of said physicians' responses to said patients' disputes;
a process for inserting said words and terms and relating monetary values into said physicians' accounts in the database or databases in said SQL server;
a process for inserting said words and terms and relating monetary values into said patients' accounts in the database or databases in said SQL server;
a process for relating said information and data on the credits representing payments credited to the physicians' accounts for health-care and health-care services provided to patients by said physicians and corresponding information and data on the debits, deductions or disbursements of funds representing payments to said physicians from said patients' accounts in the database or databases in said SQL server;
a process for relating said information and data on the credits representing payments credited to the physicians' accounts for health-care and health-care services provided to patients by said physicians and corresponding information and data on the debits, deductions or disbursements of funds representing payments to said physicians from said health-care buyers' accounts in in the database or databases in said SQL server;
a process for displaying said information and data on health-care and health-care services and related payments or compensations, debits, refunds, revenues and earnings to said physicians;
a process for displaying said information and data on health-care and health-care services and related deposits, debits, disbursements, refunds, reimbursements, credits and balances to patients;
a process for displaying data on deposits, debits, disbursements, reimbursements and balances to health-care buyers;
a process for correcting erroneous or inaccurate said information and data by physicians;
a process for correcting erroneous or inaccurate said information and data by physicians;
a process for feedbacks on said outcomes and/or products of said processes between said physicians and patients;
a process for managing, organizing and relating said information and data and said resultant information and data outcomes and products of said processes in the database or databases in said SQL server;
a process for viewing said information and data on payments, compensations, computations and accounting by physicians and patients;
a process for retrieving, displaying and effecting the viewing and uses of said information and data and products and outcomes by patients and physicians;
a process for enabling physicians and patients to retrieve, display, view, expand, manage and use said information and data and information and data outcomes and products of said scans and matches of words and terms and selected relating prices, monetary values or costs in the database or databases in said SQL server and said processes;
a process for generating said compositions by said computer or computer server or servers comprising memories, database or databases, at least a SQL server, a computer scripting language, a Web browser and innovative computer programs and software;
a process for using said compositions by physicians to reduce the repetitive efforts of physicians' productions of same, equivalent or similar said information and data and relating errors;
a process for using, manipulating, modifying, editing and/or improving said compositions;
a process for manipulating, modifying, editing and/or improving said compositions by physicians and said computer or computer server or servers;
a process for generating interactive electronic templates for generating and submitting information and data and compositions on said information and data on health, health-care and health-care services relating to diagnoses of diseases and disorders by physicians;
a process for generating, submitting, storing, relating and compiling information and data on prices, monetary values or costs of said health care and health-care services in the database or databases in and manage by said SQL server;
a process for generating interactive electronic templates for generating and submitting said information and data and compositions on information and data on prices, monetary values or costs of said health care and health-care services;
a process for retrieving and displaying and using said arrays or series of said information and data on or relating to health, health-care, health-care services in the database or databases in and manage by said SQL server by physicians and patients;
a process for generating interactive electronic templates for repetitively viewing, manipulating, modifying, editing and/or improving information and data on health, health-care and health-care services relating to diagnoses of diseases and disorders by physicians;
a process for generating interactive electronic templates for repetitively viewing, manipulating, modifying, editing and/or improving said compositions on health, health-care and health-care services relating to diagnoses of diseases and disorders by physicians;
a process for generating interactive electronic templates for repetitive uses by physicians for viewing, manipulating, modifying, editing and/or improving information and data on health, health-care and health-care services relating to diagnoses of diseases and disorders by physicians;
a process for generating interactive electronic templates for repetitive uses of said compositions by physicians;
a process for generating interactive electronic templates for repetitive submissions of manipulated, modified, edited and/or improved information and data on health, health-care and health-care services relating to diagnoses of diseases and disorders by physicians;
a process for generating interactive electronic templates for uses and submissions of contents of said compositions to said database or databases by physicians;
a process for using said compositions by physicians to enhance or optimize the accuracy of the recording of said information and data;
a process for using said compositions by physicians to assist with and/or facilitate the medical decision makings;
a process for using said compositions by physicians to reduce or eliminate errors in decision makings of physicians;
a process for using said compositions by physicians to improve and increase the efficiency of the processes of generating and recording health and health-care information and data;
a process for using said compositions by physicians to expedite the process or processes of entering and recording of said information and data into said database or databases by physicians;
a process for generating, maintaining, expanding and implementing said information and data in said databases in said SQL server;
a process for generating, maintaining and expanding said information and data and results, outcomes, products and derivatives of said processes;
a process for relating and compiling said information and data and results, outcomes, products and derivatives of said processes in said databases in said SQL server;
a process for locating or positioning—wherever feasible, achievable, workable or practicable—interactive functions, panels and tools and information and data health, health-care, health-care services and communications to physicians and patients in the right half or area of said viewing screens including touch-enabled screens or touchscreens;
a process for using said touch-enabled viewing screens or touchscreens wherein the interactive panels, tools and functions—wherever feasible, achievable, workable or practicable—are located or positioned in the right half or area of said screens.
a process for using a Web browser to retrieve and display said information and data in said database or databases in said SQL server in said computer server or servers which are viewed on Web pages appearing on said viewing screens, used and expanded by physicians and patients using said computers, portable and/or wireless communication devices to access said computer server or servers in said network or networks via the Internet; and
a process for operating and maintaining said operating and functioning computer server or servers wherein a process for implementing said computer programs and software and said networking capability, innovative computer programs and software effects the accesses, viewing and uses of said information and data and resultant information and data outcomes and products by physicians, patients and health-care buyers using computers, portable electronic communication devices via the Internet.

3. The method for composing, editing or updating and using said compositions of information and data and for editing or updating and using first versions of individual diagnoses and relating first versions of health, health-care and health-care services and for editing or updating any successive versions of individual diagnoses and any successive versions of health, health-care and health-care services relating said versions of individual diagnoses by physicians according to claim 2 comprises a process for relating, compiling and composing and editing or updating information and data on individual diagnoses and related health, health-care and health-care services relating to said diagnoses generated and use by physicians.

4. The method for composing and editing or updating and using information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts according to claim 2 comprises a process for scanning, selecting, relating and matching information and data on health-care and health-care services and relating information and data on prices, monetary values or costs of said health care and health-care services compiled and related in the database or databases in said SQL in said computer server or servers and compiling and composing information and data on said health-care, health-care services and related funds, payments, proportional payments, distributions, redistributions, adjustments, disputes, appeals, credits, debits, refunds, reimbursements, balances, revenues and earnings in the database or databases in and manage by said SQL server.

5. The method according to claim 2 wherein said process for patterning and managing the dispensations of health-care and health-care services to individual patients by individual physicians comprises a process for using said compositions and said versions of information and data in the database or databases in said SQL server by physicians.

6. The method according to claim 2 wherein said process for patterning and managing the dispensations of health-care and health-care services to individual patients by individual physicians relating to individual diagnoses or individual diagnoses in individual groups of same, equivalent or similar diagnoses of diseases and disorders comprises a process for using said compositions and said versions of information and data in the database or databases in said SQL server by physicians.

7. The method according to claim 2 wherein said process for patterning and managing the dispensations of health-care and health-care services to individual patients by individual physicians in individual groups of physicians relating to individual diagnoses comprises a process for using said compositions and said versions of information and data in the database or databases in said SQL server by said individual physicians in individual groups of physicians relating to said individual diagnoses and said patients.

8. The method according to claim 2 wherein said process for patterning and managing the utilizations of health care and health-care services by physicians comprises a process for retrieving, displaying, using, editing or updating said compositions of information and data on diagnoses and related health, health-care and health-care services and relating compositions of information and data of accounts of physicians and patients comprising arrays or series of said information and data on or relating to said diagnoses and relating health, health-care, health-care services and related funds, payments, distributions, redistributions, adjustments, disputes, appeals, credits, debits, refunds, balances, revenues and earnings in the database or databases in and manage by said SQL server by physicians.

9. The method according to claim 2 wherein said process for patterning and managing the utilizations of health care and health-care services by physicians comprises a process for using and editing or updating said versions of information and data on diagnoses and related health, health-care and health-care services and relating compositions of information and data of accounts of physicians and patients comprising arrays or series of said information and data on or relating to said diagnoses and relating health, health-care, health-care services and related funds, payments, distributions, redistributions, adjustments, disputes, appeals, credits, debits, refunds, balances, revenues and earnings in the database or databases in and manage by said SQL server by physicians.

10. The method according to claim 2 wherein said process for patterning and managing the utilizations of health care and health-care services by physicians comprises a process for using and editing or updating said versions of information and data on diagnoses and related health, health-care and health-care services and relating compositions of information and data of accounts of physicians and patients comprising arrays or series of said information and data on or relating to said diagnoses and relating health, health-care, health-care services and related funds, payments, distributions, redistributions, adjustments, disputes, appeals, credits, debits, refunds, balances, revenues and earnings in the database or databases in and manage by said SQL server by individual physicians in individual groups of physicians relating to individual diagnoses and related health-care and health-care services relating to individual patients.

11. The method according to claim 2 wherein said process for patterning and managing the utilizations of health care and health-care services by physicians comprises a process for generating, compiling and relating information and data of said compositions of information and data and accounts and said versions of information and data for retrieving and displaying patterns, standards, consensuses and logics of the practices of medicine and surgery and the dispensations and deliveries of health, health-care and health-care services to individual patients by individual physicians and by individual physicians in individual groups of physicians relating to individual diagnoses and related health, healthcare and healthcare services provided and relating to individual patients by said individual groups of physicians.

12. The method according to claim 2 wherein said process for composing and editing or updating and using information and data the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server comprises a process for matching individual diagnoses and related health, healthcare and healthcare services provided to individual patients by individual physicians in individual groups of physicians relating to said diagnoses and said patients and submitted by said physicians with same, similar and/or equivalence of said individual diagnoses and related health, healthcare and healthcare services and relating monetary values, prices or costs in the database or databases in and manage by said SQL server.

13. The method according to claim 2 wherein said process for composing and editing or updating and using information and data the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server comprises a process for individual diagnoses and related information and data on health-care and health-care services relating to individual patients generated by individual physicians in said individual groups of physicians and submitted into and compiled in the database or databases in and manage by said SQL server wherein a process for relating, compiling and retrieving said information and data in said database or databases effecting relations of proportional payments, distributions, adjustments, redistributions and readjustments of payments and debits between or among individual accounts of said individual physicians relating to said individual diagnoses and related health, healthcare and healthcare services provided to individual patients and relating disbursements of and refunds or reimbursements to said patients' account corresponding to said proportional payments, distributions, adjustments, redistributions and readjustments of payments and debits.

14. In a system of adaptable compositions of information and data on individual diagnoses and individual diagnoses in individual groups of same, equivalent or similar diagnoses of diseases and disorders and related information and data on health, health-care and health-care services and related adaptable compositions of information and data on accounts on and relating to payments for health-care and health-care services to individual physicians and relating deductions or debits and corresponding disbursements of or reimbursements to patients' accounts generated and edited or updated by physicians and a computer, a computer server or servers wherein said information and data, compositions and their successive versions and related information and data on prices, monetary values or costs of said health care and health-care services are in the database or databases in and manage by a SQL server, a method for generating, effecting and affecting patterns, standards, consensuses and logics on the practices of medicine and surgery and dispensations and deliveries of health, health-care and health-care services to individual patients by individual physicians and by individual physicians in individual groups of physicians and physicians' performances, accountability, achievements, results and related clinical, scientific and medico-economic outcomes, results and implications relating to individual diagnoses and related health, healthcare and healthcare services relating to individual patients and relating said physicians and individual groups of physicians and related information and data on payments to and deductions from physicians' accounts and corresponding disbursements from and refunds or reimbursements to patients's accounts by physicians generating and editing or updating and using individual adaptable compositions of information and data on health, health-care and health-care services and relating individual adaptable compositions of information and data on accounts of health-care funds of and among individual physicians, patients and health-care buyers and/or adding, updating, modifying or editing any versions of information and data on individual diagnoses or individual diagnoses in individual groups of same, equivalent or similar diagnoses of diseases and disorders and any relating versions of information and data on related health, health-care and health-care services relating to said versions of individual diagnoses or individual diagnoses in individual groups of same, equivalent or similar diagnoses of diseases and disorders and any successive versions of said compositions and information and data causing computer-automatically generated, edited or updated and expanded related said individual compositions of information and data on individual accounts of said individual physicians comprising information and data on payments to and deductions of individual physicians' accounts relating to individual diagnoses and related health-care, health-care services provided by individual physicians to individual patients and/or the proportional payments, distributions, adjustments or redistributions of payments and debits among individual accounts of individual physicians in individual groups of physicians relating to individual diagnoses and related health, healthcare and healthcare services provided and relating to individual patients by said individual groups of physicians and said individual compositions of accounts of individual patients comprising disbursements of and refunds or reimbursements to patients' health-care funds corresponding to said information and data in said physicians' accounts and said information and data on patterns, standards, consensuses and logics on practices and dispensations and deliveries, performances, achievements, results and related clinical, scientific and medico-economic outcomes, results and implications in the database or databases in and manage by said SQL in said computer server or servers in a network or networks of computers, mobile communication devices and said computer server or servers comprising memories, at least said SQL server, a computer scripting language, Web browsers and innovative computer programs and software wherein said information and data are displayed, viewable and used by patients and physicians to improve the efficiency of deliveries of and utilizations of health-care and health-care services and resources, to reduce the costs and wastes of health-care and health-care services and in health-care, to efficiently and effectively manage information and data on health, health-care and health-care services provided to patients and for physicians and accounting of revenues and earnings of physicians and expenses and disbursements of health-care funds of patients and companies and corporations, to improve physicians' productivity, to improve the quality of health-care and life and to reduce morbidity and mortality of patients by physicians and patients comprises:
a process for generating individual diagnoses or individual diagnoses in individual groups of same or similar diagnoses of diseases and disorders and related health-care and health-care services by individual physicians and individual physicians in individual groups of physicians relating to individual diagnoses relating to individual patients;
a process for editing or updating information and data on individual diagnoses or individual diagnoses in individual groups of same or similar diagnoses of diseases and disorders and related health-care and health-care services by individual physicians and individual physicians in individual groups of physicians relating to individual diagnoses relating to individual patients;
a process for generating individual diagnoses or individual diagnoses in individual groups of same or similar diagnoses of diseases and disorders and related health-care and health-care services by individual physicians and individual physicians in individual groups of physicians relating to individual diagnoses relating to individual patients to effect the generations of information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server;
a process for editions and/or updates of any versions of individual diagnoses or individual diagnoses in individual groups of same or similar diagnoses of diseases and disorders and/or any versions of related information and data on health, health-care and health-care services by physicians and/or by individual physicians in individual groups of physicians relating to individual diagnoses relating to individual patients to effect the generations of information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server;
a process for generating and editing or updating compositions of information and data on individual diagnoses and individual diagnoses in individual groups of same, equivalent or similar diagnoses of diseases and disorders and related information and data on health, health-care and health-care services;
a process for generating and editing or updating compositions of information and data on individual diagnoses and individual diagnoses in individual groups of same, equivalent or similar diagnoses of diseases and disorders and related information and data on health, health-care and health-care services by physicians and a computer or computer server or servers;
a process for using, editing or updating compositions of information and data on individual diagnoses and individual diagnoses in individual groups of same, equivalent or similar diagnoses of diseases and disorders and related information and data on health, health-care and health-care services by physicians;
a process for editing or updating and using first versions of individual diagnoses and relating first versions of health, health-care and health-care services and for editing or updating any successive versions of individual diagnoses and any successive versions of health, health-care and health-care services relating said versions of individual diagnoses by physicians;
a process for adding and using first versions of individual diagnoses and relating first versions of health, health-care and health-care services and for adding and using any successive versions of individual diagnoses and any successive versions of health, health-care and health-care services relating said versions of individual diagnoses by physicians;
a process for composing and editing or updating and using information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians and for composing, editing or updating and using information and data on accounts of individual patients' disbursements of and refunds or reimbursements to said patients' account corresponding to said disbursements of and refunds or reimbursements to patients' accounts in the database or databases in said SQL server generated by physicians and said computer, computer server or servers and for successively editing said compositions and versions of information and data by physicians and said computer or computer server or servers;
a process for generating, editing, updating and improving said information and data on patterns, standards, consensuses and logics on the practices of medicine and surgery and the dispensations and deliveries of health, health-care and health-care services to individual patients by individual physicians and by individual physicians in individual groups of physicians relating to individual diagnoses and related health, healthcare and healthcare services provided and relating to individual patients by said individual groups of physicians and related information and data on the performances, achievements, results and related clinical, scientific and medico-economic outcomes, results and implications in the database or databases in said SQL by said computer server or servers as outcomes of physicians generating, editing or updating and using said adaptable compositions of information and data on individual diagnoses and related information and data on health, health-care and health-care services and said related adaptable compositions of information and data on accounts;
a process for displaying said information and data on patterns, standards, consensuses and logics on the practices of medicine and surgery and the dispensations and deliveries of health, health-care and health-care services and related information and data on the performances, achievements, results and related clinical, scientific and medico-economic outcomes, results and implications in the database or databases in said SQL;
a process for defining and affecting the dispensations of health-care and health-care services to patients by physicians and the dispensations of individual diagnoses or individual diagnoses in individual groups of same, equivalent or similar diagnoses of diseases and disorders and related information and data on health, health-care and health-care services provided to patients by physicians;
a process for defining and affecting the dispensations of health-care and health-care services to individual patients by individual physicians in individual groups of physicians relating to individual diagnoses in individual groups of same, equivalent or similar diagnoses of diseases and disorders and related health, healthcare and healthcare services provided and relating to individual patients by said individual groups of physicians;
a process for generating, maintaining and expanding said information and data and results, outcomes, products and derivatives of said processes;
a process for relating and compiling said information and data and results, outcomes, products and derivatives of said processes in databases in said SQL server;
a process for using a Web browser to retrieve, display and update, expand and improve said information and data in said database or databases in said SQL server in said computer server or servers in a network or networks of computers, mobile communication devices and said computer server or servers comprising memories, at least said SQL server, a computer scripting language, Web browsers and innovative computer programs and software which are viewed on Web pages appearing on said viewing screens by physicians and patients using said computers, portable and/or wireless communication devices to access said computer server or servers in said network or networks via the Internet; and
a process for operating and maintaining said operating and functioning computer servers wherein a process for implementing said computer programs and software and said networking capability, innovative computer programs and software effects the accesses, viewing and uses of said information and data and resultant information and data outcomes and products by physicians, patients and health-care buyers using computers, portable electronic communication devices via the Internet.

15. The method according to claim 14 wherein said process for generating, editing, updating and improving said information and data on patterns, standards, consensuses and logics on the practices of medicine and surgery and the dispensations and deliveries of health, health-care and health-care services to individual patients by individual physicians and by individual physicians in individual groups of physicians relating to individual diagnoses and related health, healthcare and healthcare services provided and relating to individual patients by said individual groups of physicians and related information and data on the performances, achievements, results and related clinical, scientific and medico-economic outcomes, results and implications in the database or databases in said SQL by said computer server or servers as outcomes comprises a process for generating, editing or updating, compiling, relating and using information and data which are outcomes and results of the generations, editions or updates, compilations, relates and uses of the adaptable compositions of information and data on individual diagnoses and related information and data on health, health-care and health-care services and said related adaptable compositions of information and data on accounts and first versions of individual diagnoses and relating first versions of health, health-care and health-care services and any successive versions of individual diagnoses and any successive versions of health, health-care and health-care services relating said versions of individual diagnoses and information and data on accounts on payments and distributions or deductions of payments to physicians' accounts relating to individual diagnoses and related health-care and health-care services and individual patients and/or the proportional payments, distributions, adjustments, redistributions and readjustments of payments and debits between or among individual accounts of individual physicians in individual groups of physicians relating to individual diagnoses and related health, healthcare and healthcare services provided to individual patients by said individual groups of physicians by physicians and of the disputes of payments and disbursements and withholdings of payments to physicians by patients and responses to patients'disputes and withholdings by physicians.

16. The method according to claim 14 wherein said process for defining and affecting the dispensations of health-care and health-care services by physicians or by individual physicians in individual groups of physicians relating to diagnoses and individual patients comprises a process for generating, compiling, relating, retrieving and displaying information and data on patterns, standards, consensuses and logics of the practices of medicine and surgery and the dispensations and deliveries of health, health-care and health-care services to individual patients by individual physicians and by individual physicians in individual groups of physicians relating to individual diagnoses and related health, healthcare and healthcare services provided and relating to individual patients by said individual groups of physicians.

17. The method according to claim 14 wherein said process for defining and affecting the dispensations of health-care and health-care services by physicians or by individual physicians in individual groups of physicians relating to diagnoses and individual patients comprises a process for generating, editing or updating, compiling, relating and using information and data which are outcomes and results of the generations, editions or updates, compilations, relates and uses of the adaptable compositions of information and data on individual diagnoses and related information and data on health, health-care and health-care services and said related adaptable compositions of information and data on accounts and first versions of individual diagnoses and relating first versions of health, health-care and health-care services and any successive versions of individual diagnoses and any successive versions of health, health-care and health-care services relating said versions of individual diagnoses and information and data on accounts on payments and distributions or deductions of payments to physicians' accounts relating to individual diagnoses and related health-care and health-care services and individual patients and on disputes of payments and disbursements and withholdings of payments to physicians by patients and responses to patients' disputes and withholdings by physicians.

18. The method according to claim 14 wherein said process for defining and affecting the dispensations of health-care and health-care services by individual physicians in individual groups of physicians relating to diagnoses and individual patients comprises a process for generating, editing or updating, compiling, relating and using information and data which are outcomes and results of the generations, editions or updates, compilations, relates and uses of the adaptable compositions of information and data on individual diagnoses and related information and data on health, health-care and health-care services and said related adaptable compositions of information and data on accounts and first versions of individual diagnoses and relating first versions of health, health-care and health-care services and any successive versions of individual diagnoses and any successive versions of health, health-care and health-care services relating said versions of individual diagnoses and information and data on accounts on proportional payments, distributions, adjustments, redistributions and readjustments of payments and debits between or among individual accounts of individual physicians in individual groups of physicians relating to individual diagnoses and related health, healthcare and healthcare services provided to individual patients by said individual physicians in said individual groups of physicians and on disputes of payments and disbursements and withholdings of payments to physicians by patients and responses to patients' disputes and withholdings by physicians.
